(19) United States
(12) Patent Application Publication
(10) Pub. No.: US 2016/0001346 A1
(43) Pub. Date: Jan. 7, 2016

(54) SYSTEM INCLUDING CARTRIDGE, CARTRIDGE FEE SYSTEM, PRE-SWAGING ASSEMBLY, TUBE BENDER, CUTTING AND DEBURRING STATION, AND AIR BLOWER/VACUUM CHIP COLLECTOR

(71) Applicant: SSP Fittings Corp., Twinsburg, OH (US)

(72) Inventors: Terrance Holder, Chagrin Falls, OH (US); Jeffrey King, Hudson, OH (US); Trevor Jackson, Kirtland, OH (US); James Edward Szpak, Cleveland Heights, OH (US); Shawn Dellinger, University Heights, OH (US); Robert F. Soreo, Cleveland Heights, OH (US)

(73) Assignee: SSP FITTINGS CORP.

(21) Appl. No.: 14/739,398

(22) Filed: Jun. 15, 2015

Related U.S. Application Data
(63) Continuation-in-part of application No. PCT/US2013/075498, filed on Dec. 16, 2013.
(60) Provisional application No. 61/737,421, filed on Dec. 14, 2012.
(60) Provisional application No. 61/755,674, filed on Jan. 23, 2013.

(51) Int. Cl. B21D 39/04; B25B 27/10; B21D 7/02

(52) U.S. Cl. CPC B21D 39/046; B21D 7/02; B25B 27/10

(57) ABSTRACT

A swaging system includes a unique cartridge containing a nut and ferrule combination. The cartridge or cartridges are fed to a loading station where the nut and ferrules are removed from the cartridge, properly oriented or aligned on the tube end, and pre-swaged to the tube end. System also includes a kit that includes a tube bender, a cutting station, a deburring station, and a blower/vacuum chip collector.

This application is a continuation-in-part of and claims the priority benefit of PCT/US13/075498, filed Dec. 16, 2013, and also claims the priority benefit of U.S. Ser. Nos. 61/737,421, filed Dec. 14, 2012 and 61/755,674, filed Jan. 23, 2013, the PCT and provisional disclosures of which are each expressly incorporated herein by reference.

### BACKGROUND

The use of first and second ferrules in connection with a nut that is threaded onto a fitting body to connect stainless steel tubing (a.k.a., a double ferrule fitting assembly) has been commercially used for many years. Installation requires the installer to assemble a tube fitting which includes a fitting body, a first or front ferrule, a second or rear ferrule, and a nut, on to a tube or tubing such as stainless steel tubing.

Failure to properly tighten the nut and ferrules the correct number of turns on to the fitting body could result in leakage of the tube connection. In addition, the process of making fittings, especially in a production OEM environment, can be time-consuming and fatiguing.

On the other hand, when properly made, an advantage of this type of connection is the ease of installation that assures a reliable, leak free gripping of the tube, an effective gas seal, and resistance against vibration. The present arrangement is intended for use with the preparation of tubing and pre-swaging of fittings up to ¾″ tubing.

U.S. Pat. No. 2,484,815; U.S. Pat. No. 3,075,793; and U.S. Pat. No. 3,103,373 are representative of the basic double ferrule fitting tube fitting technology, and the disclosures are expressly incorporated herein by reference for purposes of brevity.

### SUMMARY

A cartridge includes a body having first and second spaced walls that form an internal cavity dimensioned to receive an associated nut and hold the nut from rotation relative to the body. An advancement surface on the body is configured for engagement to move the body. At least one retention finger holds the associated nut within the internal cavity of the body. A keying feature on the body is adapted for engagement by an associated locking mechanism that determines whether the associated nut is separated from the body.

At least one retention finger further includes a deflectable holding member that extends into engagement with the associated nut and deforms in response to a predetermined force to allow the associated nut to be removed from the body.

The at least one retention finger includes at least one frangible finger that separates from the body in response to a predetermined force that allows the associated nut to be removed from the body.

The body is preferably formed from plastic and is joined to at least one contiguous, like body.

Contiguous bodies are joined by frangible connections.

A mechanism loading station is dimensioned to receive the cartridge in a cartridge feed system for a tube fitting assembly that includes first and second annular ferrules received on a tube and swaged in place between a nut and a body.

The nut includes first and second ferrules received therein, and an advancing mechanism that engages the advancing surface on the cartridge to advance the cartridge to a loading station.

The cartridge feed system further includes a locking mechanism that engages the keying feature on the body, and if the locking mechanism engages the body, a plunger is freed for advancement to move toward the cartridge and breaks the cartridge from a contiguous cartridge.

The cartridge feed system further includes a movable plug mounted for advancement into one end of the nut, and first and second ferrules, for holding the nut and ferrules in aligned position as the advancing mechanism separates the cartridge from the contiguous cartridge.

The plug moves with the advancing mechanism during the separation of the cartridge from the contiguous cartridge.

The cartridge feed system further includes an opening dimensioned to receive one end of a tube therein for axial advancement relative to the nut and ferrules after the nut and ferrules have been removed from the cartridge.

The cartridge feed system further includes a plug housing that receives the plug as the tube is axially inserted into the nut and ferrules.

In the cartridge feed system, the plug moves away from the tube end with the nut and ferrules received thereon.

The contiguous, next cartridge is advanced into the loading position, and any additional joined cartridges are advanced seriatim toward the loading position.

Cartridge feed system further includes a pre-swaging device that includes a generally U-shaped die barrel configured to receive the nut and first and second ferrules therein, and a force applying mechanism that pre-swages the ferrules on the tube.

A cartridge feed system for a tube fitting assembly that includes first and second annular ferrules received on a tube and swaged in place between a nut and body includes a loading station dimensioned to receive a nut having first and second ferrules received in the nut. The advancing mechanism then advances the nut with ferrules into the loading station.

The advancing system of the feed system separates a cartridge containing a nut with the first and second ferrules received therein from like cartridges that each include a nut containing first and second ferrules therein.

A tube bender includes a mandrel having at least one recess dimensioned to receive an associated tube. A base is operatively secured to the mandrel, and the base is configured to alternatively allow the mandrel to be mounted in one of different, first and second positions relative to the base.

The base includes a plate mounted to an associated work surface.

A first slot is dimensioned to receive the base in the first position, and a second slot is substantially perpendicular to the first slot and dimensioned to receive the base in the second position.

A swaging tool includes a body having a recess. A removable die is received in the recess, and a switch is also received in the recess for detecting the receipt of a ferrule assembly and a tube in the recess. A force applying mechanism pre-swages the ferrule assembly on the tube.

A cartridge receiving cavity of the swaging tool is dimensioned to align a ferrule assembly in the recess and whereby the force applying mechanism urges the ferrule assembly into the die for swaging on the tube.

A base of the swaging tool is configured for pivoting on an associated work surface, and the base receives a handle of the tool.

A deburring tool assembly includes a base configured for mounting on an associated work surface. A chuck is mounted on the base and receives an associated tube. A motor rotates the chuck and associated tube relative to the base. A deburring tool is configured for deburring one of an inner or outer diameter of a tube end selectively rotated in the chuck.

A swaging kit includes a housing that receives a motor and compressor. A tube bender and rotatable chuck are selectively connected to the motor, and the kit also includes a swaging tool.

The swaging kit further includes one or more of a vacuum/air pressure tool, a deburring tool, at least first and second removable dies selectively received in the swaging tool, a cutting tool, and a cartridge receiving plural ferrule sets for selectively supplying a dual ferrule assembly to the swaging tool.

It is desirable to be able to bend tubing of various sizes and wall thicknesses in a manner that allows various orientations or angles. Likewise, a tube bender that provides for a precise, measured angle with little flattening or distortion is desired. Moreover, when advancing through a heavy bend, it is desirable that no spring back occur, i.e., no tension be lost that has been exerted on the tube.

There is a distinct advantage to providing a single unit that can be used with various tube sizes without having to change parts or procedures. Moreover, the tube bender must be capable of achieving bends in excess of 180°, as well as complex shapes with accurate bends in multiple planes.

Accordingly, a need exists for an improved tube bender that addresses one or more of these needs in a compact, reliable, economic manner, and that may be easily mounted as part of a bench-top system if so desired.

A need exists for an accurate, repeatable tube cutter that provides for even cutting pressure, and can accommodate short or long tubes or tubing. Power for operation will preferably be a small electric motor, i.e., one that can be plugged into a standard 120 V receptacle. It is also desirable that a commercial tube cutter be adaptable to different wall thicknesses, and facilitate easy changeover without additional components or process steps.

The system is advantageously a self-contained unit.

Another benefit is a cartridge and cartridge loading system that eliminates errors in pre-swaging first and second ferrules on a tube.

Another advantage resides in the self-contained power supply (motor and compressor) required to operate the various components of the kit.

Still other benefits and advantages of the present disclosure will become apparent upon reading and understanding the following detailed description.

### BRIEF DESCRIPTION OF THE DRAWINGS

FIG. 1 schematically illustrates a bench top that includes various items of the swaging system of the present disclosure.

FIGS. 2A-2C show a portable kit that is self-contained, and many of the individual components illustrated in the swaging system of FIG. 1 are included in the kit.

FIGS. 3A-3C are perspective views of a swaging tool in either a mobile (FIG. 3A) or mounting arrangement (FIGS. 3B-3C).

FIGS. 4A-4C are perspective views of the swaging tool capable of receiving various sized dies, and a nut/ferrule assembly (including from a cartridge).

FIGS. 5-8 show a second embodiment of a cartridge.

FIGS. 9-20 illustrate a second embodiment of a cartridge feed system.

FIG. 21 shows a slightly modified cartridge feed system that includes a telescoping plunger to align the nut/ferrule assemblies.

FIGS. 22 and 23 show alternate mounting arrangements of a tube bender.

FIGS. 24 and 25 show a cutter of the present disclosure.

FIG. 26 illustrates deburring of the cut tube.

FIG. 27 shows the use of a pressurized air blower or a vacuum arrangement for collecting chips.

FIGS. 28-34 are various perspective views of the subject tube bender illustrated at different steps in a bending process.

FIGS. 35-37 are similar perspective views of the tube bender used to perform offset bending.

FIG. 38 illustrates an example of a tube with offset bending.

FIGS. 39-41 are views showing the anti-spring back lock, and a bend indicator needle.

FIGS. 42-44 are perspective views of a tube cutter assembly of the present disclosure.

FIG. 45 is a longitudinal cross-section through the tube cutter assembly of FIG. 1.

FIGS. 46-47 illustrate how different components can be axially separated.

### DETAILED DESCRIPTION

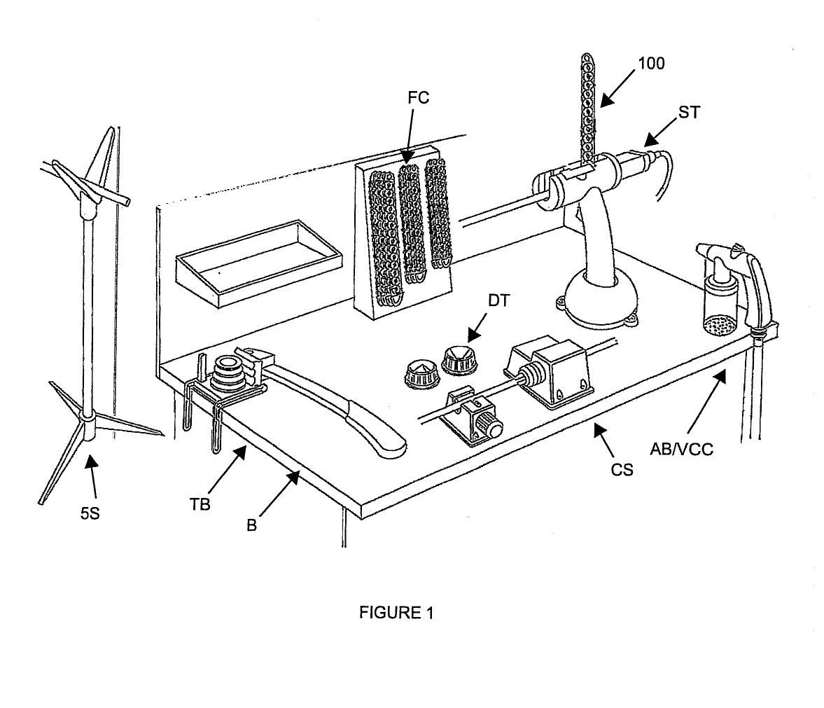

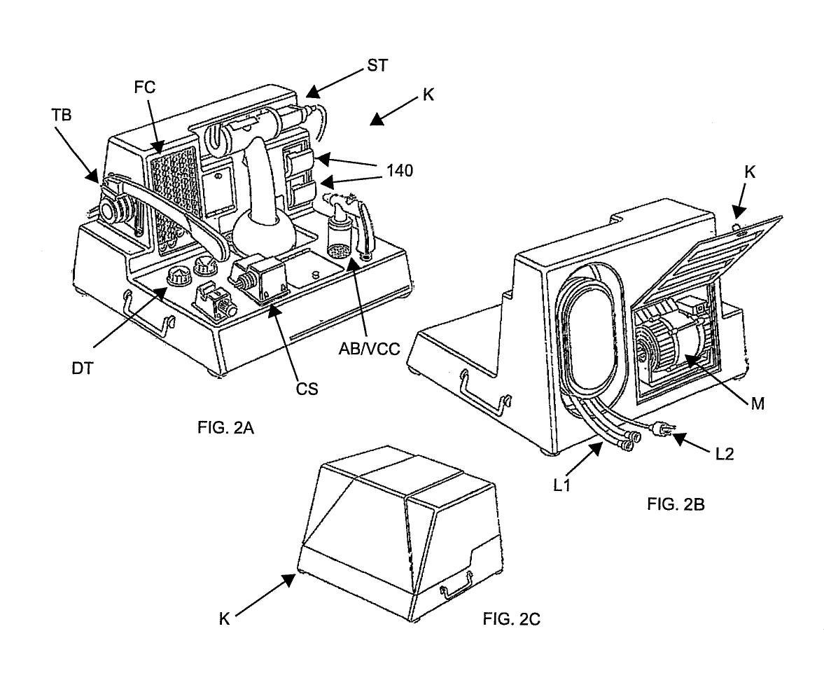

Turning first to FIG. 1 and FIGS. 2A-2C, there is shown a swaging system 100 having a variety of components used for different stages of a swaging (or pre-swaging) operation, or used in conjunction with other ones of the illustrated components. For example, some of the components of the swaging system 100 include a swaging tool ST, a tube bender TB, a cutting station CS, deburring tool(s) DT, a support stand SS, an air blower/vacuum with chip collector AB/VCC, and nut/ferrule cartridges FC, although some or all of these components can be individually provided and/or used with alternative components. In addition, the following description may refer to swaging or pre-swaging of components. It is generally understood that pre-swaging refers to swaging or securing first and second ferrules with an associated nut onto a tube, which subassembly may subsequently be secured to a final fitting assembly where the nut is threaded onto a thread portion of an associated fitting body. For example, since the first and second ferrules are already swaged or pre-swaged on the tube, advancement or rotation of the nut relative to the fitting body, e.g. for the balance of a complete make-up, assembly, or installation, will complete makeup or assembly. Thus, the term swaging as used herein can more generically refer to and include pre-swaging or complete swaging.

A kit K (FIGS. 2A-2C) can be used for storage and/or transport of the swaging system 100. For example, the kit K conveniently stores all of the components noted above (except for the support stand SS) and the kit also includes a self-contained motor M, such as an electric powered motor, that operates selected ones of the components or tools, and/or is used in conjunction with a compressor (driven by the motor M) to provide desired vacuum or air pressure via lines L1, L2 (FIG. 2B). As also illustrated in FIG. 2C, the kit K may be closed for storage and transport if so desired.

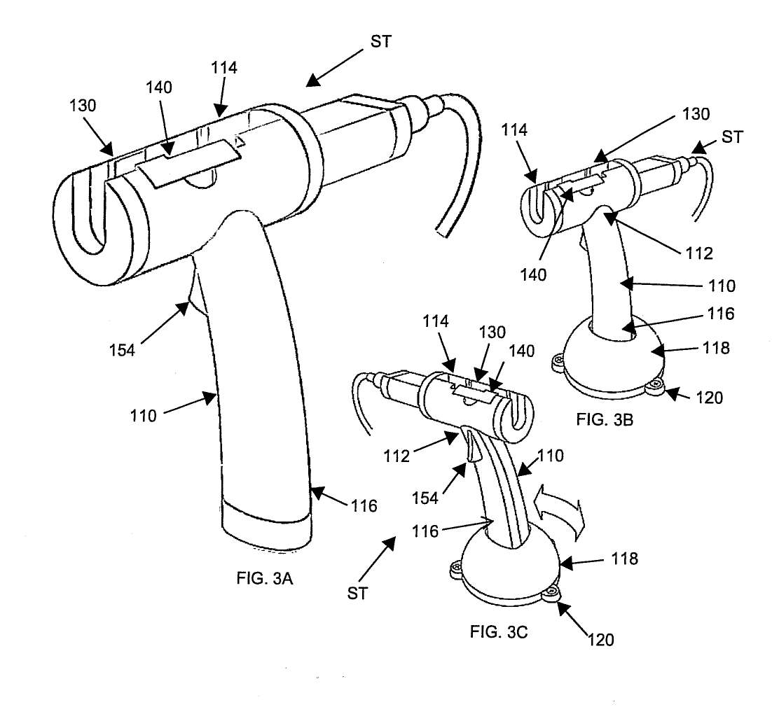

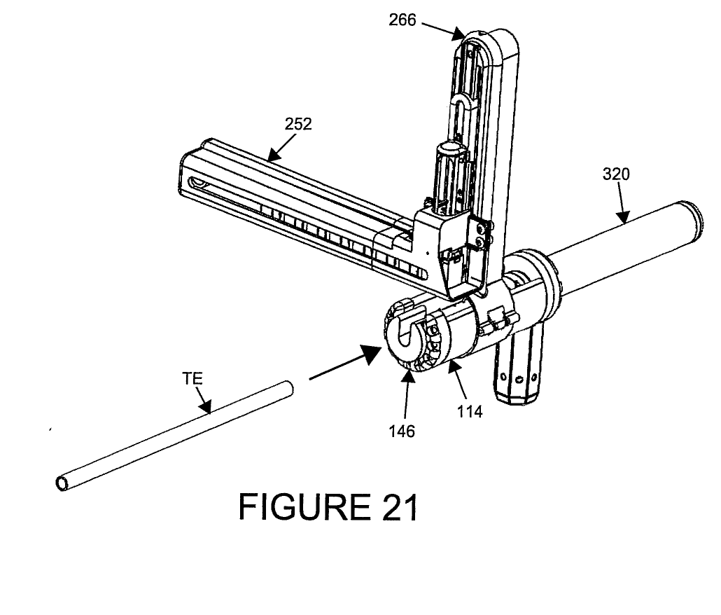

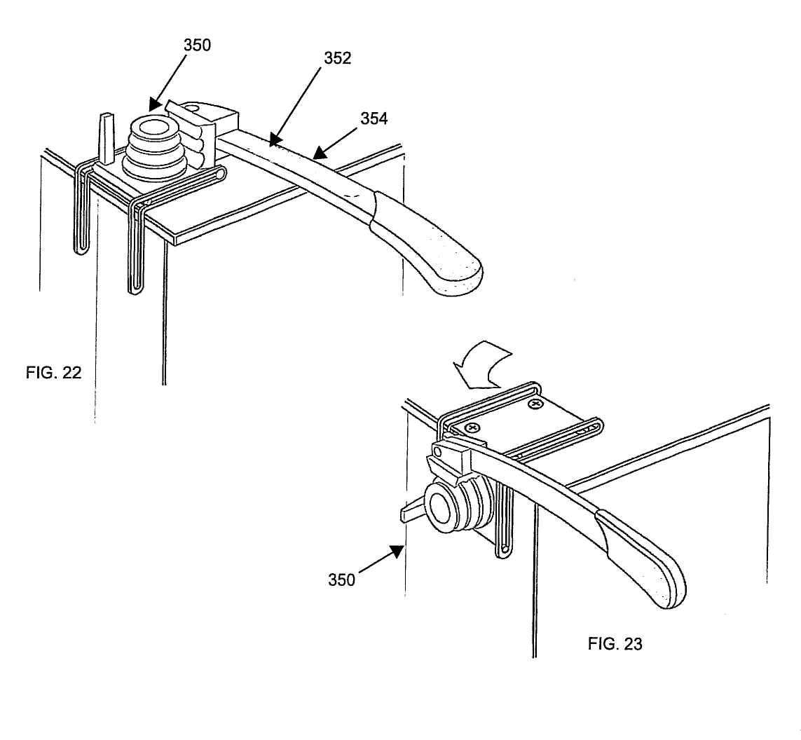

With continued reference to FIG. 1, FIGS. 2A-2C, and additional reference to FIGS. 3A-3C, there is shown the swaging or pre-swaging tool ST that includes a handle 110 dimensioned to be easily gripped by an installer/user (not shown) when used as a portable tool. The handle 110 is connected at a first or upper end 112 with a swaging carriage or barrel 114 and a second or lower end 116 of the handle is dimensioned for receipt in a base 118, for example, that may be secured via fasteners 120 to a bench B, floor (not shown), or similar support surface. Alternatively, the swaging tool ST, namely the handle 110 and swaging carriage or barrel 114, may be separated from the support surface/base 118 for portable operation where a user grips the handle 110 and an open recess 130 is provided in a top of the carriage 114. Still further, and as will be appreciated from the following description (e.g. FIG. 21), the tool ST may be incorporated into a cartridge feed system where (i) a nut, and first and second ferrules are dispensed from an individual cartridge, (ii) the nut and ferrules properly aligned and assembled on a tube, and (iii) the tube with the aligned nut and ferrules loaded into the swaging tool ST where a piston or ram, for example, performs the ferrule swaging operation that secures the nut and ferrules to the tube.

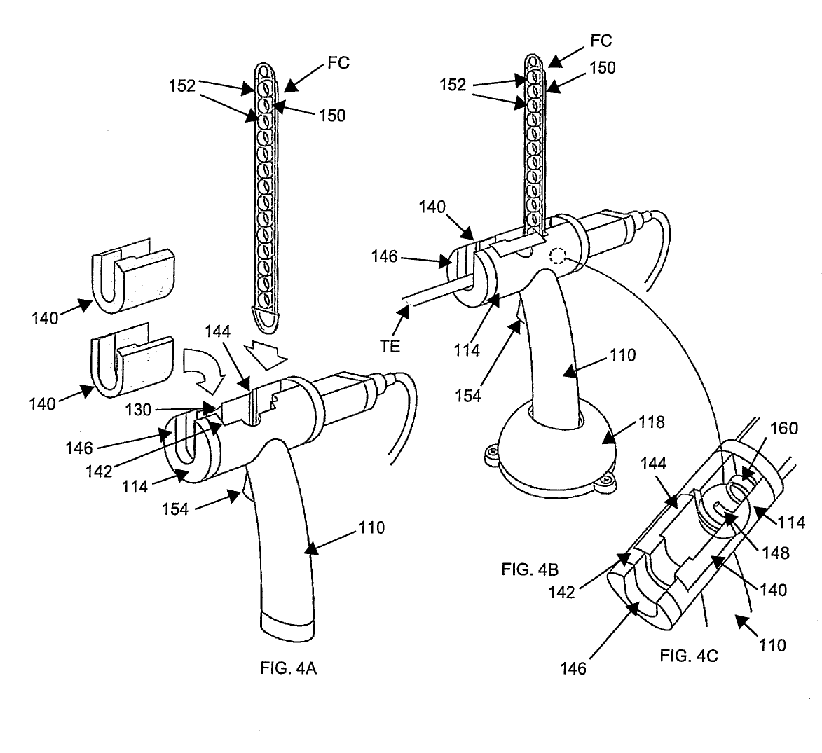

The user selectively installs a desired die 140, i.e., a die of a predetermined size (see FIG. 2B and FIG. 4A) in the recess 130 of the swage carriage 114. For example, it is preferable that each die 140 has similar outer dimensions and similar conformation to permit easy interchange and receipt in the carriage recess 130 of the tool ST, while the inner cavities of each die are dimensioned for different size tubing and nuts for different sized fittings (e.g., ¼″, ½″, and ¾″ tubing/fittings, or still other tubing/fitting sizes). The die 140 is loaded into the recess 130 of the swaging carriage 114 and the U-shaped cross-sectional conformation allows the die to be easily inserted and removed from the recess. The recess 130 of the tool ST has spaced shoulders 142, 144 that limit axial movement of the die 140 relative to the carriage recess 114 during the pre-swaging operation. Similarly, the swage carriage 114 includes a U-shaped recess 146 in one end that aligns with the U-shape of the die 140 and allows a tube end TE (e.g., FIG. 4B) to be axially inserted through the recess 146, or radially inserted from the top of the carriage, into the recess 130 toward the bight of the U-shape.

As shown in FIGS. 4A and 4B, one form of a cartridge assembly 150 is inserted into the recess 130 of the swaging carriage 114. The cartridge assembly 150 carries a preselected number of nut and ferrule combinations 152 (specifically an internally threaded nut that captures a first or front ferrule and also captures a second or rear ferrule). One of the nut/ferrule combinations 152 of the cartridge assembly 150 is axially aligned with the tube end TE at one end of the die 140. By actuating (e.g. depressing) a switch 154 in the handle 110, a movable member such as a piston or ram 160 (FIG. 4C) in the swaging carriage 114 is advanced (or rotated) by the motor/compressor (fluid pressure) so that the nut and ferrules 152 are advanced (or rotated) over the tube end TE into the U-shaped recess of the die 140 where one of the ferrules abuttingly engages a shoulder in the die and a predetermined swaging (or pre-swage) of the ferrules on to the tube end is completed. Once the pre-swaging (or complete swaging) operation is complete, the ram 160 is retracted, and the tube end TE with the nut and ferrules assembly 152 pre-swaged (or completely swaged) thereon is removed from the swaging carriage 114. In addition, the next adjacent nut/ferrule combination 152 in the cartridge assembly 150 is advanced (e.g. by gravity, spring force, etc.) for use in the next pre-swage or swage operation. Various features are provided by this new disclosure. For example, trigger, floor-mount, or base-mounted actuation of a swaging operation is provided. A pivoting base for 2-axis adjustment of swaging orientation for optimal tube loading is provided.

A handle 110 of the swaging tool ST is removable from the base/cradle 118 to allow for remote pre-swaging (involves setting or swaging of ferrules on to the tube in a die prior to installation on a fitting). The handle 110 can hold a hydraulic ram used to pre-swage or swage the ferrules. The hydraulic pressure may come from either electric or fluid (e.g., air, hydraulic) power. A cartridge or cassette system is thus provided for automatically dispensing nut and ferrule sets into a swaging station or swaging tool ST.

In one arrangement, the handle 110 of the swaging tool ST is perpendicular to the swaging ram action (in swaging carriage 114). Further, it is contemplated that the system is advantageously adaptable to use fitting components of other manufacturers. For example, the cassette system could be a single magazine, cartridge, or cassette (preferred with the nut and ferrule combinations loaded therein), or a system with different cassettes that join together, or individual feed channels that individually feed different nut and ferrule components required for make-up that either converge to introduce the components, or are individually, separately loadable on to the swaging tool. Likewise, different sizes or types of dies can be provided.

A sensor 148 may be provided in the recess of the swaging carriage which triggers swaging action of the ram. For example, the sensor is activated when a tube comes into full circumferential contact with a bottom of the die. This prevents inadequate insertion of tubing which can potentially cause functional failure of the tubing assembly under pressure. Swaging is preferably performed by a linear action which brings the components together to a preset distance by use of a fixed hard stop for each fitting size. This method reduces errors that may be caused by misjudging ‘finger-tight” or by miscounting turn(s) in the conventional turn method.

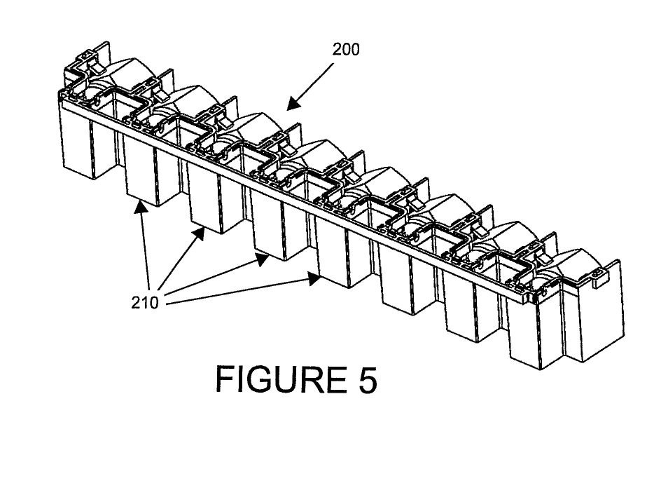

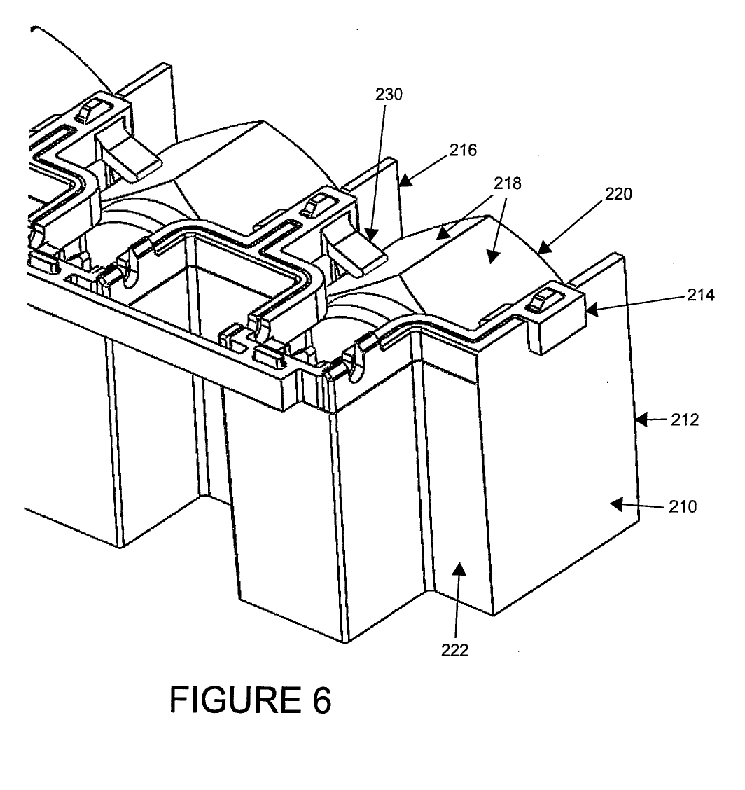

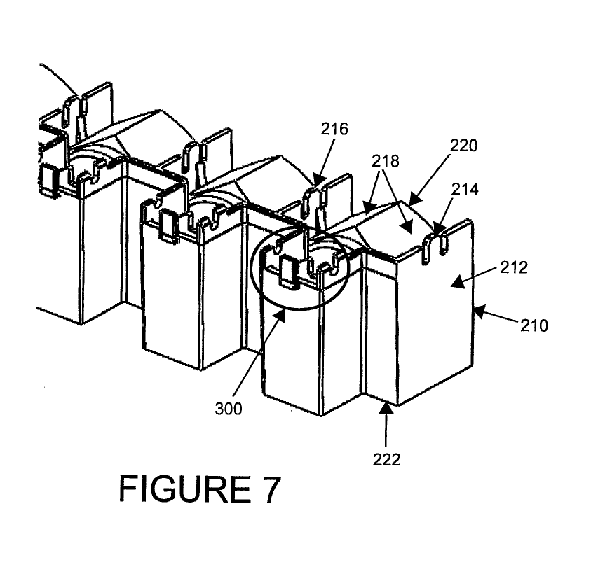

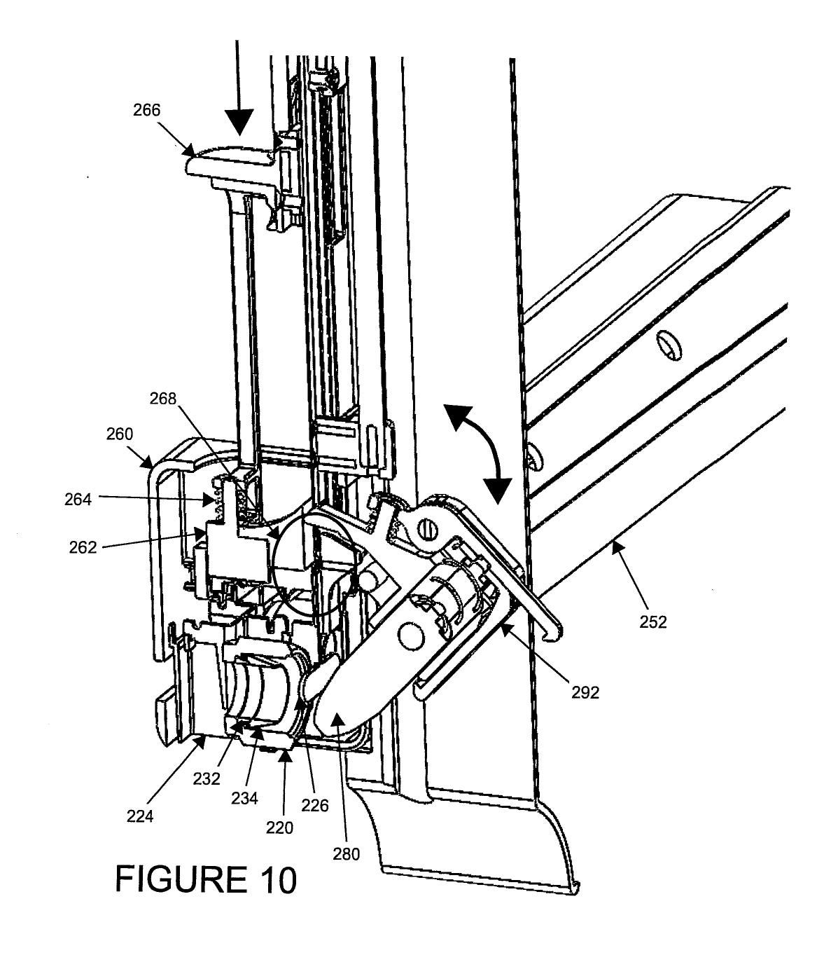

An alternate embodiment of a cartridge assembly 200 is shown in FIGS. 5-8. Particularly, as seen in FIG. 5, ten cartridges 210 are shown joined together in side-by-side fashion. Each cartridge 210 is identical to the other unless noted otherwise. In this arrangement, the cartridge assembly 200 orients the individual cartridges 210 in horizontal fashion (rather than the vertical relation shown in FIG. 4). Each cartridge 210 includes a body 212 that has a cavity that is formed at least in part by first and second sidewalls 214, 216 disposed in spaced, generally parallel relation (and one sidewall may be shared between adjacent cartridges). The sidewalls 214, 216 are designed to be spaced apart by a dimension that closely approximates that of parallel tool flats 218 provided on the external surface of the nut 220 in the nut/ferrule assembly 222. Although not particularly evident in FIGS. 6-8, a front wall 222 of the cartridge includes an extension or protruberance 224 (FIGS. 10-12) that is received in one end of the nut 220, and a tab 226 (FIG. 10) extends between the sidewalls 214, 216 and the tab abuts the opposite end of the nut. As a result, the nut 220 is held against axial movement within the cartridge, for example, via the protruberance 224 at one end and a tab 226 at the other end. In addition, and as evident in FIG. 6, each cartridge 210 includes at least one finger 230 that holds the nut 220. It is contemplated that the finger 230 is configured to break away, while other fingers of the cartridge 210 may simply deform or deflect in response to a predetermined force. Therefore, for example, the sidewalls 214, 216 prevent rotation of the nut 220 relative to the cartridge 210, bottom fingers 230 and the top finger 230 hold the nut against vertical movement relative to the cartridge, and the protuberance 224 and tab 226 prevent axial movement of the nut relative to the cartridge. The first and second ferrules 232, 234 of the nut/ferrule assembly are received within the interior of the nut 220 and thus also advantageously held in place by the cartridge 210. In this way, the front and rear ferrules 232, 234 can be properly oriented relative to the nut 220 to limit the potential for improper installation.

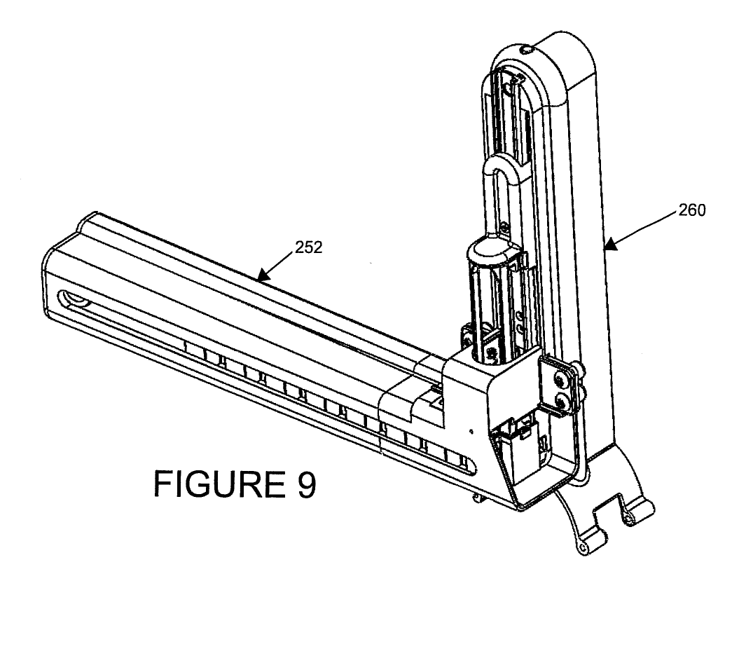

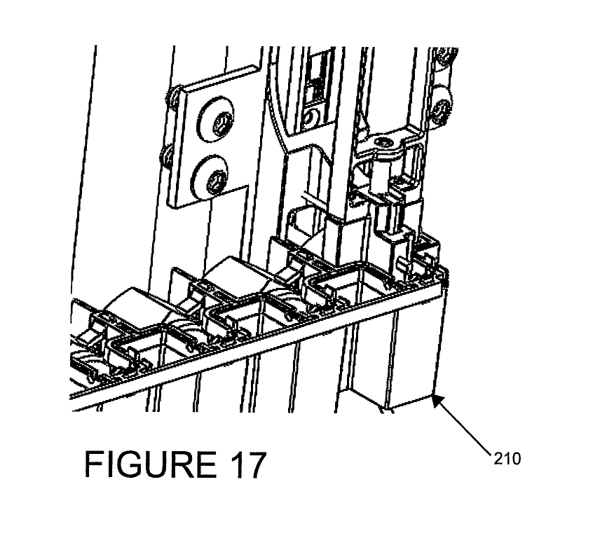

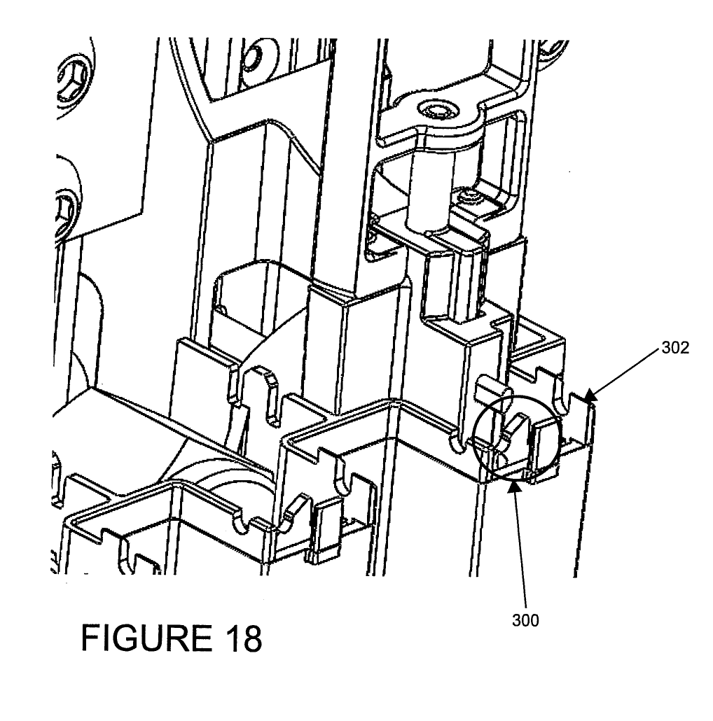

The sidewalls 214, 216 of one cartridge 210 can be designed to break relative to a contiguous sidewall of an adjacent cartridge in response to a predetermined force, i.e., adjacent cartridges 210 separate along contiguous sidewalls. Alternatively, the adjacent cartridges 210 may remain essentially intact and instead portions of the cartridges, for example tab 226 and top finger 230, designed to deflect or break away in response to forces imposed by a cartridge feed system 250 such as shown and more particularly described in connection with FIGS. 9-20.

The cartridge assembly 200 (FIG. 5) is loaded into a cartridge feed system and more particularly a hollow sleeve 252 (FIG. 9). The cartridge assembly 200 is selectively advanced in the sleeve 252, such as in the illustrated horizontal direction, under the biasing force of a spring (not shown), for example, although other advancing mechanisms may be used for urging the cartridges toward a loading station without departing from the scope and intent of the present disclosure.

The cartridge feed system 250 includes a loading station 260 along the path of the hollow sleeve 252, and is particularly shown in the exemplary embodiment as being adjacent one end of the sleeve. The loading station 260 includes a plunger 262 that is normally biased by spring 264 into an upper, retracted position. An actuating force such as downward pressure imposed by a user on actuating surface 266 overcomes the spring force 264 to selectively remove the nut and ferrule assembly from the cartridge 210 situated or located in the loading station. The unnumbered arrow represents a downward force imposed on the actuating surface 266 to advance plunger 262 against the nut and ferrule assembly held in a cartridge in the loading station, and with sufficient force separating the nut and ferrule assembly from the individual cartridge.

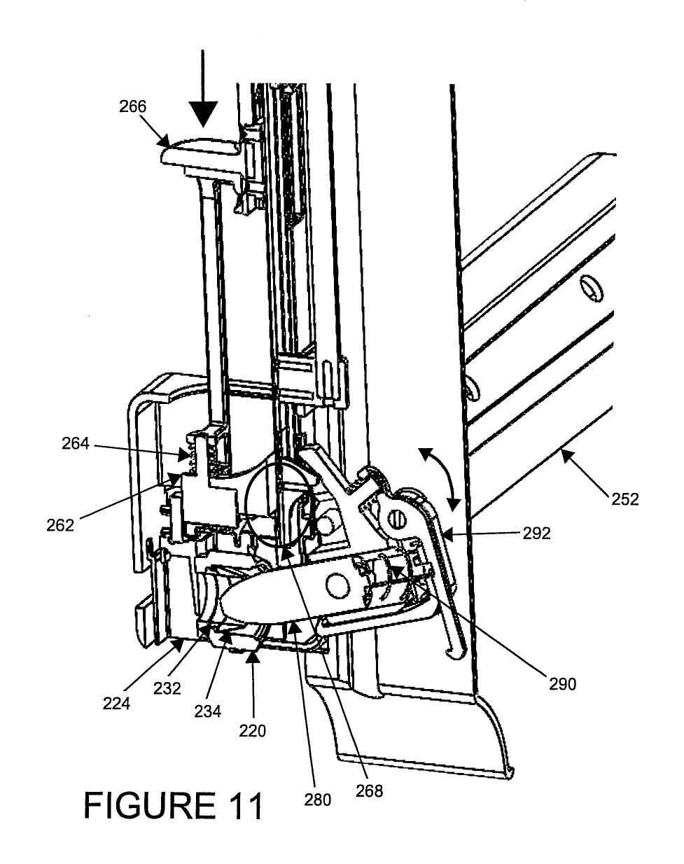

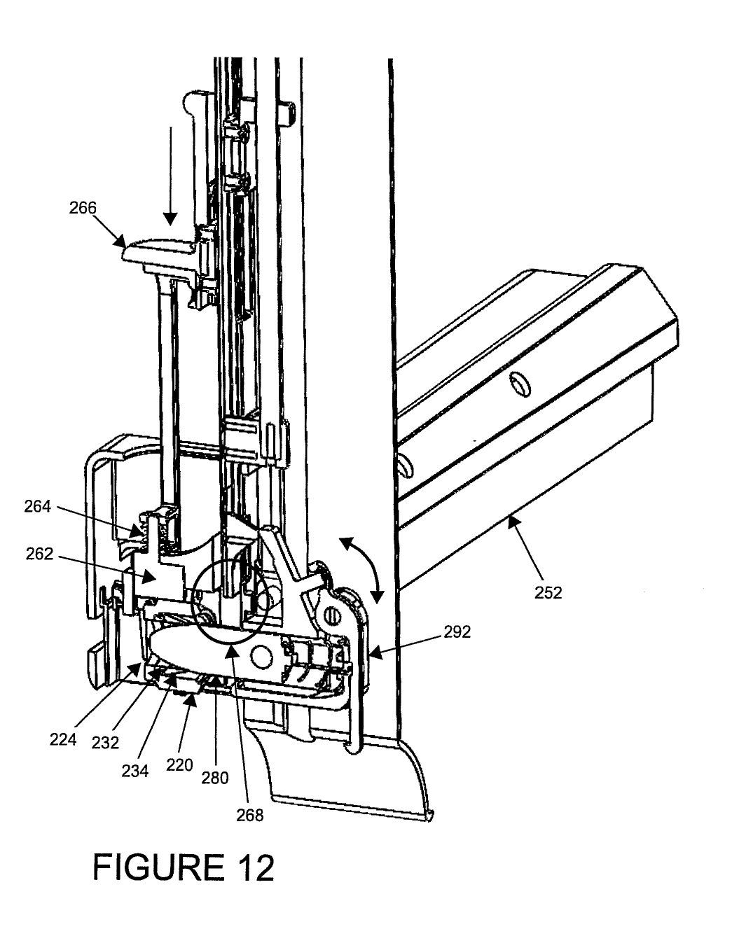

More particularly, when the actuating surface 266 is initially depressed, a cam arrangement 268 pivots a plug 280 from a storage position (generally vertical orientation of FIG. 10) so that the nose end 282 of the plug is pivoted and advanced into the central openings in the nut 220 and first and second ferrules 232, 234. As a part of the downward movement of the plunger 262, the cam arrangement 268 breaks away the tab 226 of the cartridge (compare FIGS. 10 and 11) to allow access by the plunger into the central openings of the ferrules 232, 234 and nut 220. This provides the desired access to one end of the nut 220 so that the nose end 282 of the plug 280 advances into the end of the nut and ultimately into the first and second ferrules 232, 234 and maintains the desired orientation or alignment of these components.

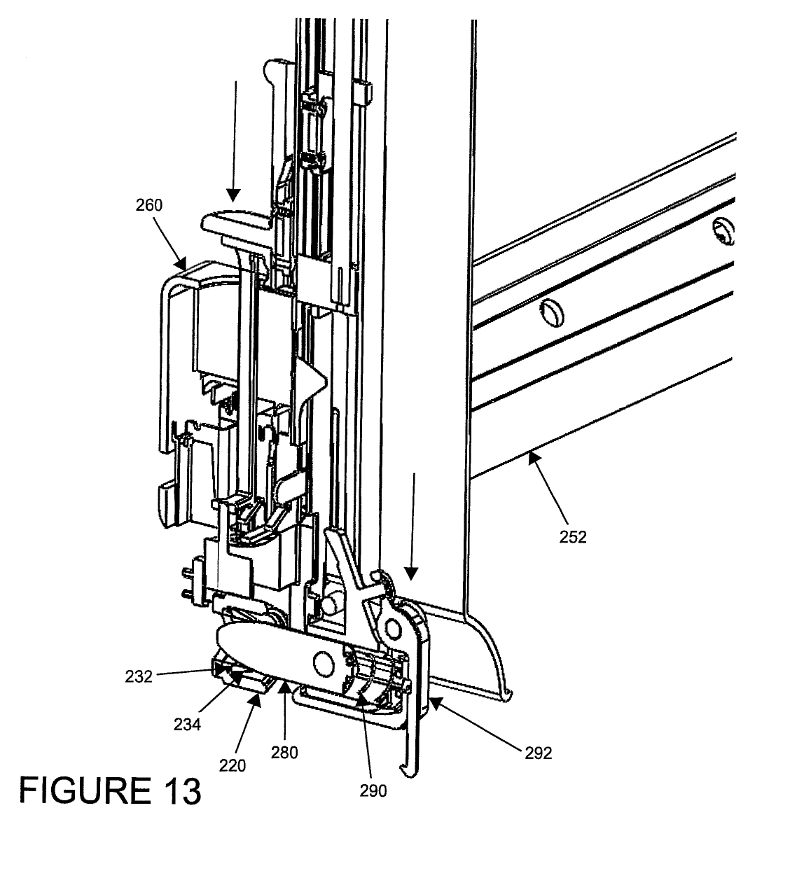

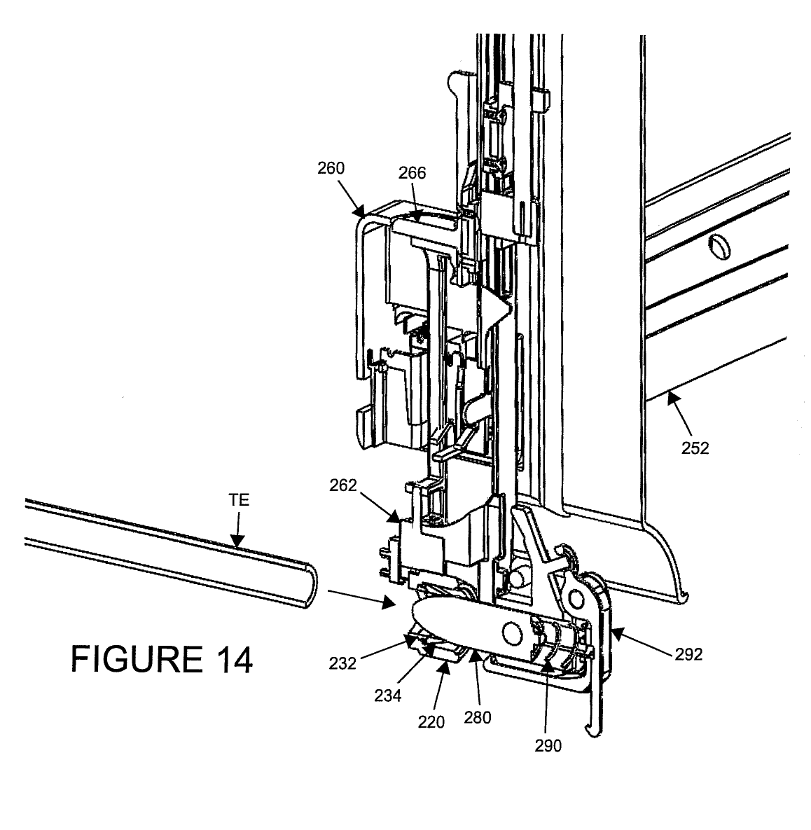

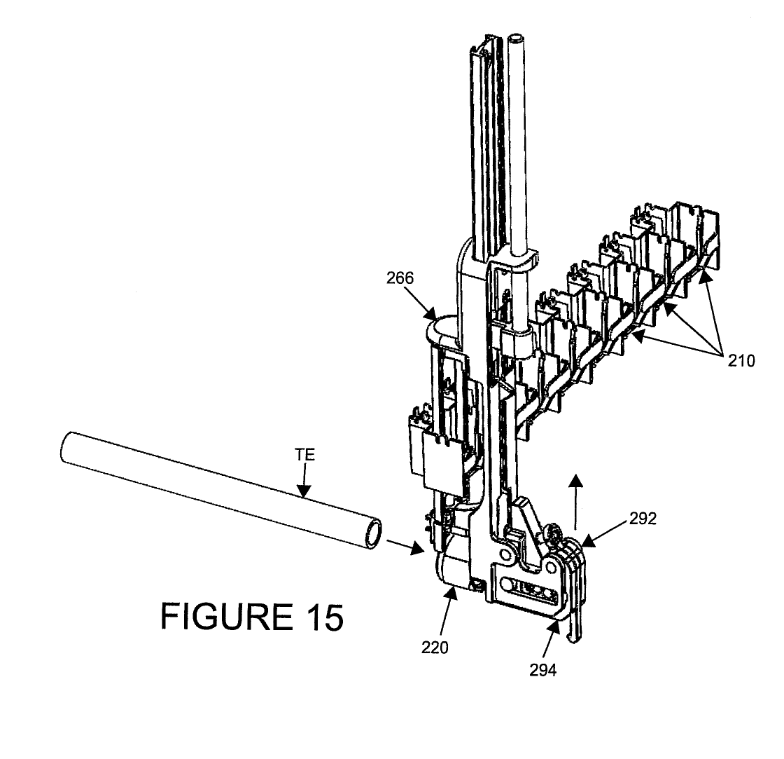

With the plug 280 positioned in place within the nut 220 and ferrules 232, 234 (FIG. 12), further axial advancement of the plunger 262 breaks the upper finger 230, for example, and deforms the lower fingers so that the nut and ferrule assembly 222 (maintained in desired alignment on the plug) can be removed from the remainder of the cartridge body 212 (FIG. 13). As illustrated in FIG. 14, the actuating surface 262 and thus the plunger 262 have been fully depressed and positioned so that a tube end TE can be inserted into the opposite end of the nut 220 while the plunger is fully depressed. Insertion of the tube end TE (through the central openings of the nut 220 and ferrules 232, 234) engages the plug 262 and pushes the plug rearwardly and overcomes the biasing force of spring 290 (FIG. 14). As further illustrated in FIG. 15, as the tube end TE is inserted, the plug is pushed back into plug housing 292 and the plug 280 rides along a release lever 294 (FIG. 15). The plug 280 then releases and returns to the top of the stroke of the plunger mechanism, and the next cartridge 210 is advanced to the loading station and readied for assembly of the next nut/ferrule assembly on a tube end. Thus, the plug 280 is positioned in the aligned openings and moves downwardly with the plunger 262 for the bottom portion of its stroke as the nut 220 and ferrules 232, 234 break through the bottom of the cartridge 210.

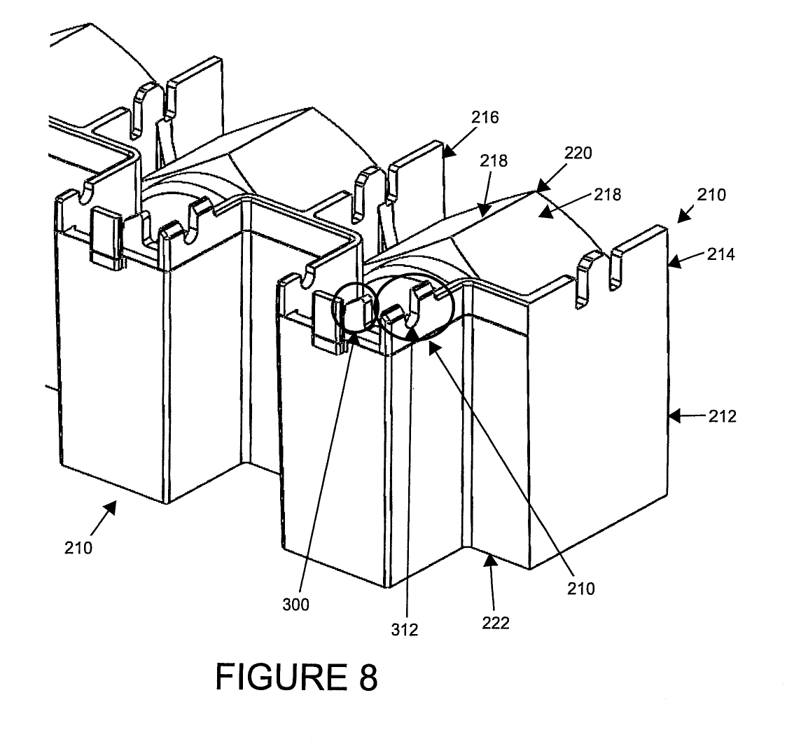

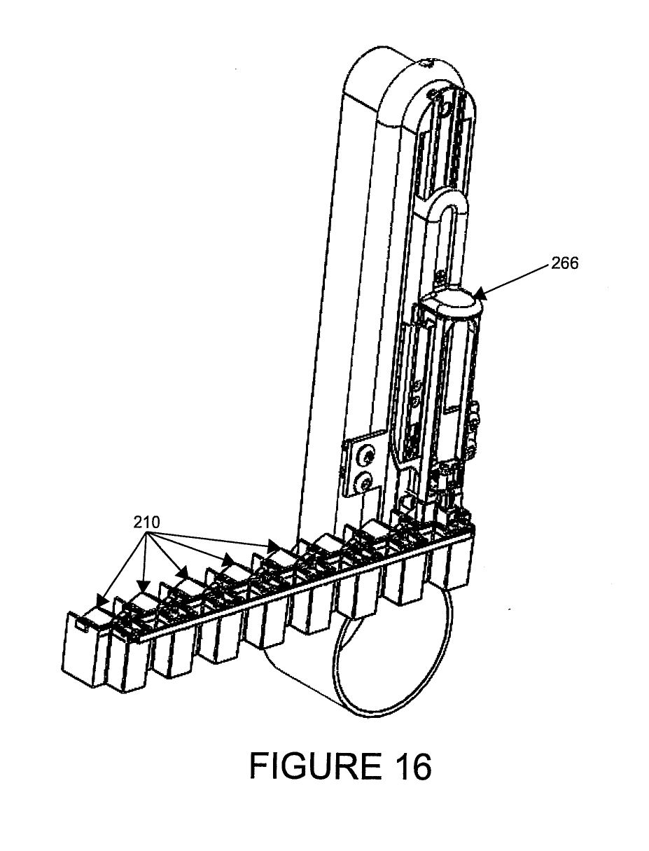

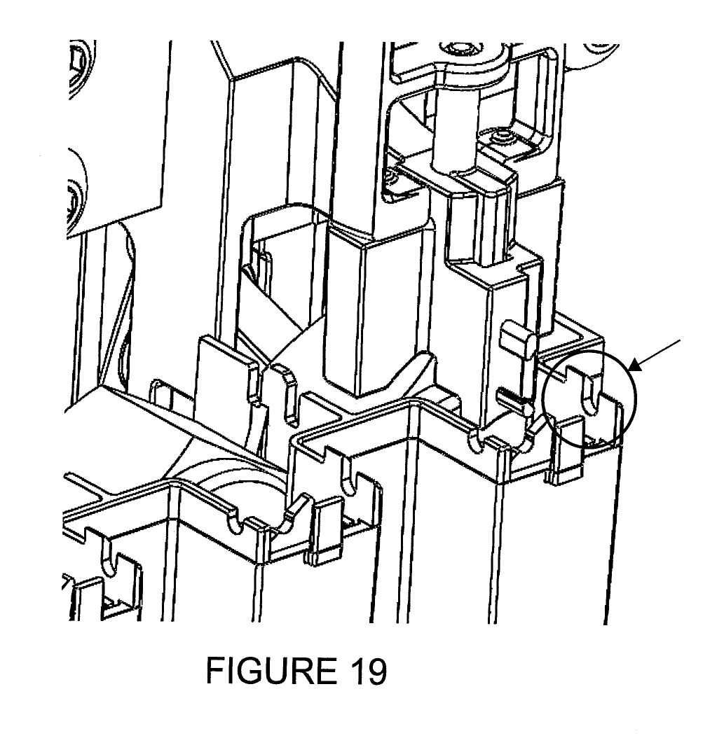

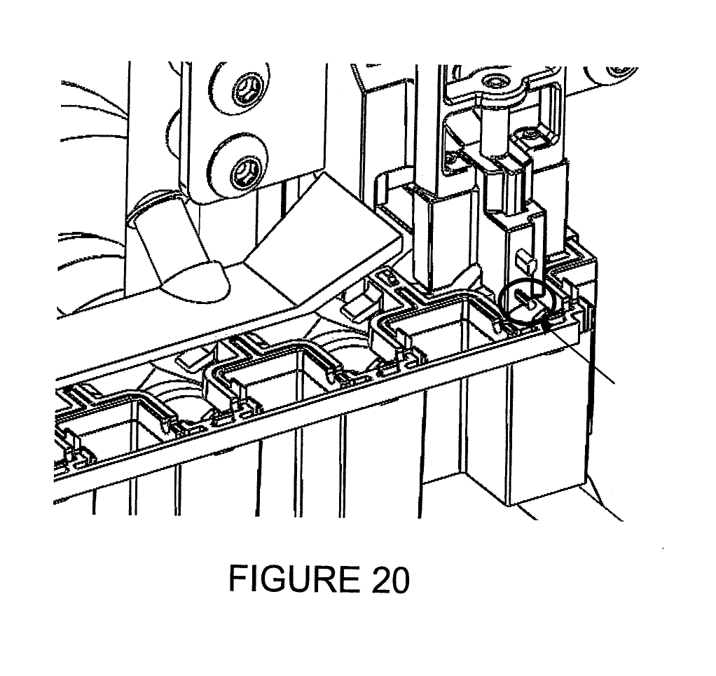

FIGS. 16-20, as well as FIG. 8, show the particular details of the cartridge structure that provides for functional aspects associated with the feed system. For example, the joined cartridges 210 are advanced toward the loading station 260. When an individual cartridge is received in the loading station, a stop 300 on the cartridge body engages an associated stop 302 in the loading station. This ensures proper advancement of the cartridge 210 in the loading station 260. In addition, a key assembly such as a protrusion or pair of protrusions 310 having a space 312 therebetween (FIG. 8) cooperate with a locking mechanism 314 (FIG. 19). For example, the locking mechanism 314 includes first and second members 316, 318 that are respectively engaged by the protrusions 310 on an acceptable cartridge. If the cartridge does not include the protrusions 310, then the locking member 316 and/or 318 are not engaged and thus movable lock 320 will not move from a locked position (FIG. 19) to an unlocked position (FIG. 20). The movable lock 320 is operatively associated with the plunger, and if the lock does not move to the unlocked position of FIG. 20, the plunger 262 is unable to freely move as a user tries to depress the actuating surface 266. Thus, the protrusions 310 on a cartridge can be spaced or dimensioned for cooperative action with the locking mechanism 314 and to prevent inadvertent loading of a nut and ferrule combination of an unauthorized cartridge if desired. Of course still other key and locking arrangements can be used without departing from the scope and intent of the present disclosure.

FIG. 21 illustrates receipt of a swaging tool ST into a lower portion of the cartridge feed mechanism. That is, in connection with installment of the nut 220 and ferrules 232, 234 on to the tube end TE as shown and described with respect to FIGS. 9-15, the cartridge feed mechanism can also be configured to receive the swaging tool ST. Specifically, once the nut 220 and ferrules 232, 234 are separated from the cartridge 210, the loading station advances these components directly into the recess of the swage tool ST. This embodiment of an alignment head 320 is a telescoping type and no longer requires pivoting action of a plug as described in connection with the embodiment of FIGS. 9-15. Instead, the telescoping alignment head 320 uses a telescoping plunger to align the nut/ferrule assemblies in the swaging carriage of the swage tool ST to minimize chances for jamming. A tube end TE is thus inserted into U-shaped recess 146 in one end of the swaging carriage 114, i.e., and in the end of the swaging carriage opposite that of the telescoping alignment head 320. Once inserted in the tube end, and the telescoping alignment head 320 properly positioning the nut and ferrules over the tube end TE, the piston of the swaging tool is advanced to complete the swaging/pre-swaging operation and deform the ferrules 232, 234 into the external surface of the tube end.

With regard to FIGS. 22 and 23, some of the noted features of a bending assembly include a rail-mounted bending die mandrel 350 for re-orientation of a bending operation, for example, in connection with a 2-axis bending operation. Thus as seen in FIG. 22, the mandrel 350 is disposed in a horizontal position for example on a table surface or bench while in FIG. 23, the mandrel is reoriented in the rail mounting to be about 90° from that shown in FIG. 22 (i.e., vertical). A ratchet-style bender 352 (generally known in the art) allows an installer to effect full radius bends without drawing the bending arm 354 around the full bend radius. This minimizes operator fatigue by incrementally achieving the desired bend radius at a point of maximum leverage for the operator. The bender 350 includes different size mandrels that allow for standard bend radii based on tubing size.

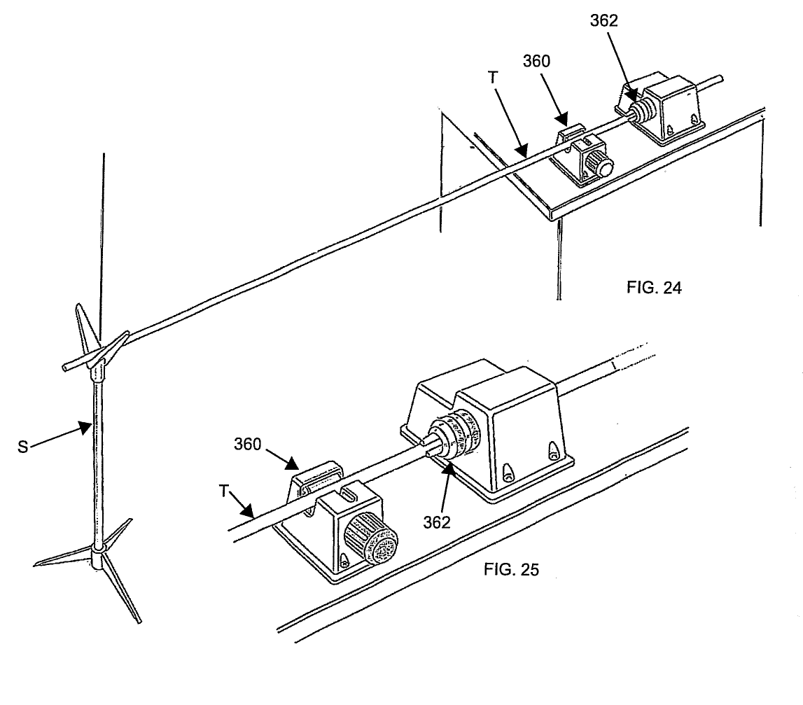

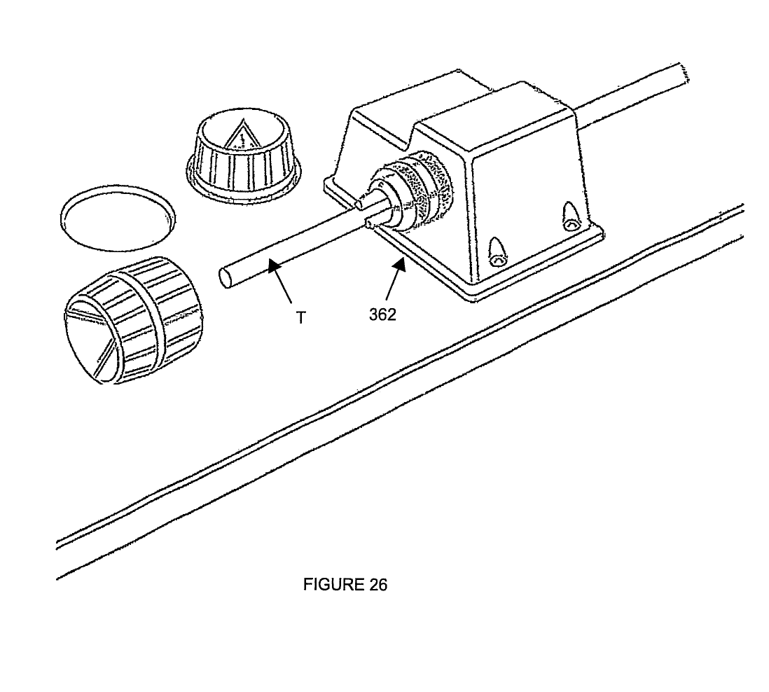

Some of the advantageous features illustrated in FIGS. 24 and 25 include a cutting wheel 360 that centers on tubes T of various diameters. Further, a spring pre-loaded cutter 360 advances cutting pressure evenly as a spindle 362 rotates the tube T, although other cutter styles can be used, e.g., hacksaw-type cutter, plasma arc torch type cutter, etc. The cutter 360 uses standard style cutting wheels that are of displacement type and are replaceable. For long tubing T, the use of an outboard support S will be provided in the kit. The revolutions per minute (RPM) of the cutting head will be optimized for cutter wear and safety. Power for the spindle 362 will be provided by a small electric motor, e.g., provided by the kit K (wiring not shown). Use of a powered spindle 362 also allows the user to manually debur the inner diameter (ID) and outer diameter (OD) of the recently cut tube end while it is still mounted in the spindle (FIG. 26).

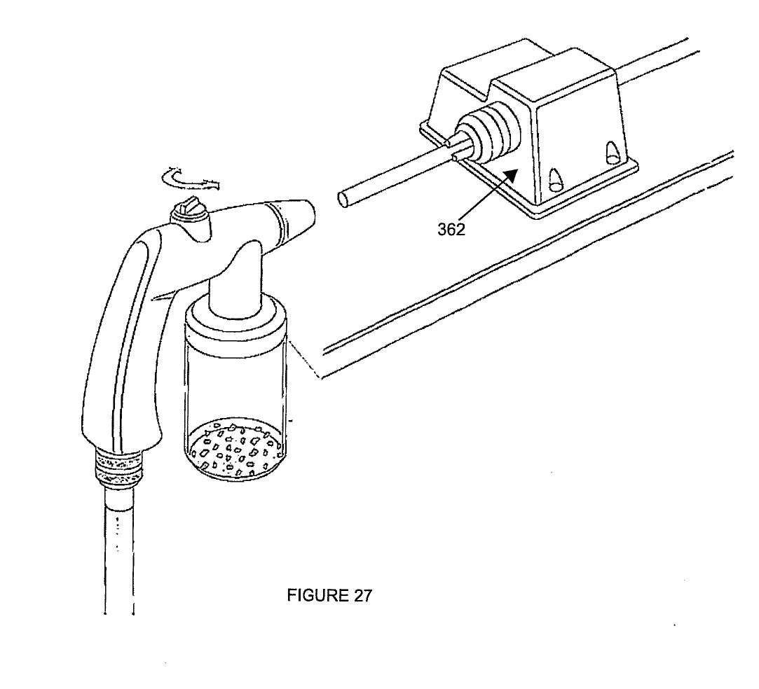

FIG. 27 represents the use of pressurized air or negative pressure (vacuum) or a combination of pressurized air and vacuum (remove large chips with vacuum and then apply pressurized air, or vice versa, or pressurized air creates a venturi) for chip removal associated with clearing chips from the deburring process.

The kit K offers all the tools needed for standard tubing preparation and pre-swaging (or swaging). It is designed to be available in pieces and parts for someone only requiring specific features, or as an all-inclusive workstation. The features that the kit K will be capable of are as follows: tube cutting; tube end deburring (both ID and OD); chip extraction; pre-swaging (manual and auto insertion of nut/ferrules)(swaging); and tube bending.

A fully-contained production center with unique anchoring system will permit selective detachment of workpieces from a base (optionally) and/or quickly mounting to a work station in whatever configuration suits the operator. For example, a cutting station with spindle on one base plate; a 2-axis bending station on one base plate; and/or a swaging station on one base plate can be used. The kit offers storage options for components needed for a particular project.

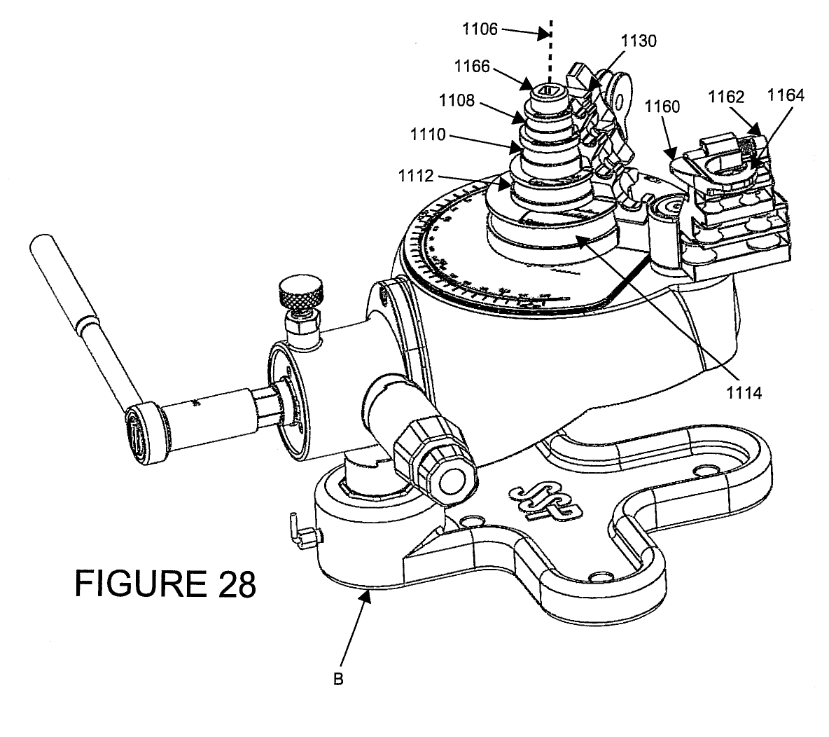

Turning to FIGS. 28-34, there is shown a tube bender assembly 1100 that includes a bend die 1102 and a roll die 1104. The bend die 1102 is mounted for selective, incremental rotation relative to base B about an axis such as vertical axis 1106. The base B includes part of the drive mechanism (the internal mechanism or gearing not shown) for rotating the bend die, for example, via a drive tool such as the illustrated socket wrench drive DR or other similar drive mechanism. The bend die 1102 preferably includes multiple mandrel sizes (e.g., arcuate recesses 1108, 1110, 1112, and 1114) adapted to receive different size tubing. By way of example only, the different sized recesses may be dimensioned for receipt of ¼″, 5/16″, ⅜″ and ½″ tubing, although other sized recesses may be used to accommodate different sized tubing such as metric sizes, e.g., 6 mm, 8 mm, 10 mm, and 12 mm. These recess dimensions are exemplary only and should not be deemed limiting even though these are common tubing sizes, and likewise, various aspects of this disclosure would also apply to a bend die having a greater or lesser number of recesses. Shown here, the different mandrel recesses 1108, 1110, 1112, 1114 are stacked one atop the other (terraced) and the recesses extend over a partial or less than complete circumference. In this illustrated arrangement, the bend die 1102 rotates as a unit, i.e., all of the arcuate recesses are fixed relative to one another and thus driving motion of one recess is preferably imparted simultaneously to all recesses, although it is contemplated that this may not necessarily be the case.

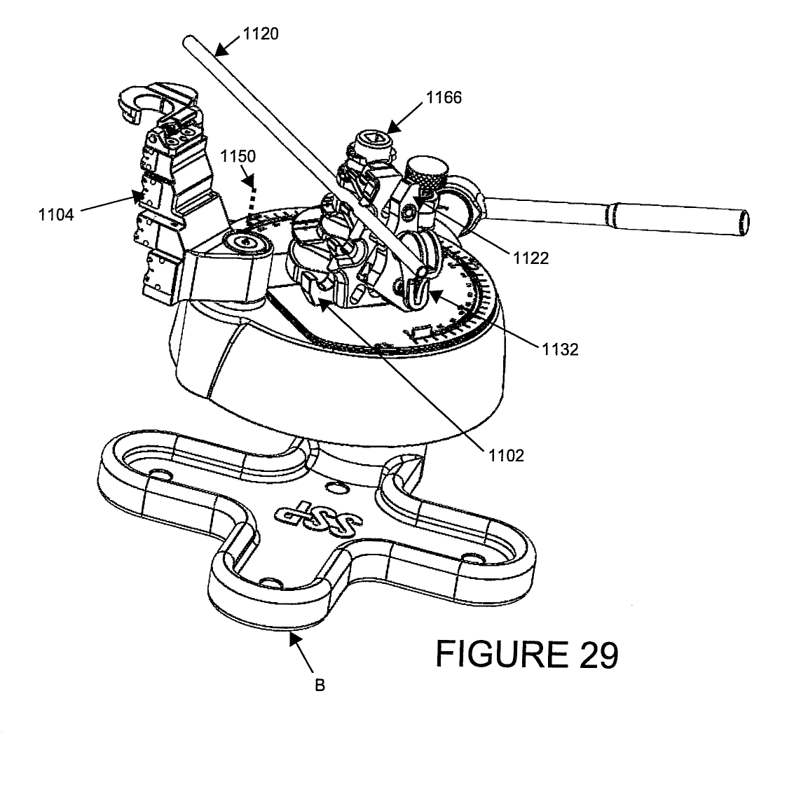

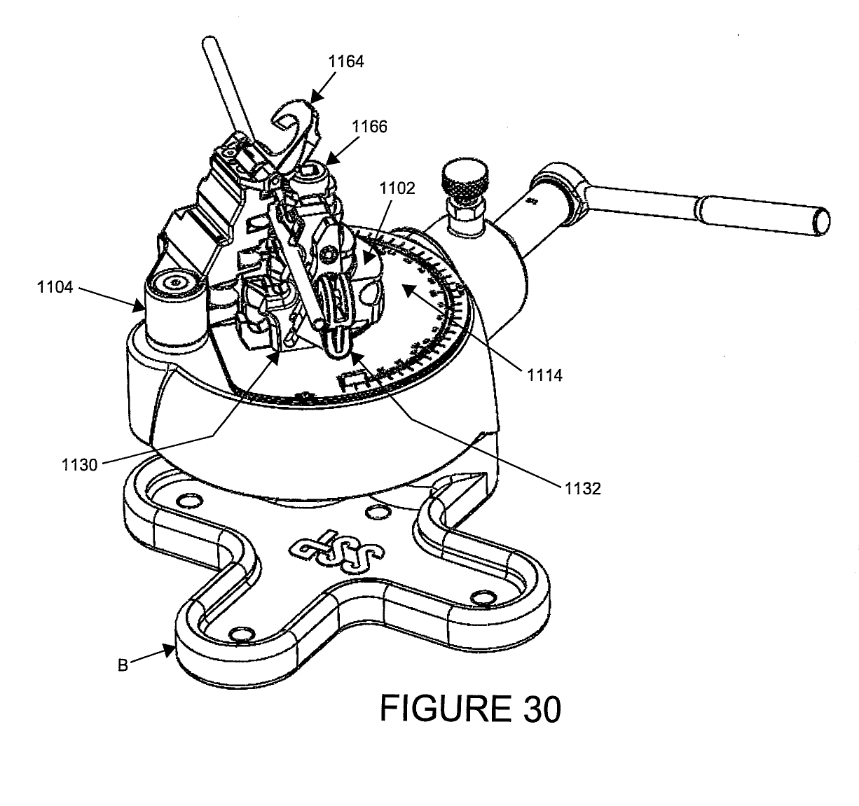

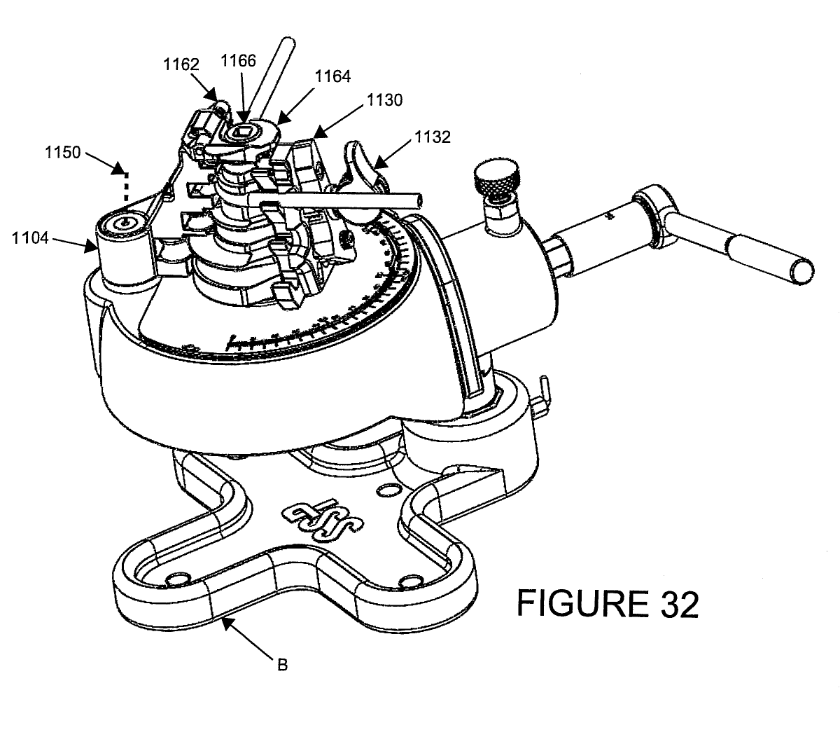

A tube 1120 of a selected size is selected by the user, and one end 1122 thereof slid into the bend die 1102 in the recess (one of recesses 1108, 1110, 1112, 1114) of the corresponding dimension (FIG. 29). A tube latch 1130 engages or secures the one end 1122 of the two 1120. For example, the latch 1130 may be a plate that is initially loosely secured to the bend die 1102 and has a series of hook-shaped extensions or latches (FIGS. 30 and 32) that are dimensioned for receipt over a substantial circumferential portion (e.g. greater than 180°) of the tube end 1122. The tube end 1122 is positioned in the desired mandrel recess of the bend die 1102, and handle 1132 of the latch 1130 rotated or tightened to urge the latch against a face of the bend die and thereby secure the tube end for rotational movement with the bend die 1102. As a result of tightening the latch 1130, a substantial circumferential portion of the tube end 1122 is secured by the latch and another circumferential portion of the tube 1120 is secured in the selected mandrel recess 1106, 1108, 1110, 1112 to tightly secure or hold the tube end for rotation with the bend die 1102.

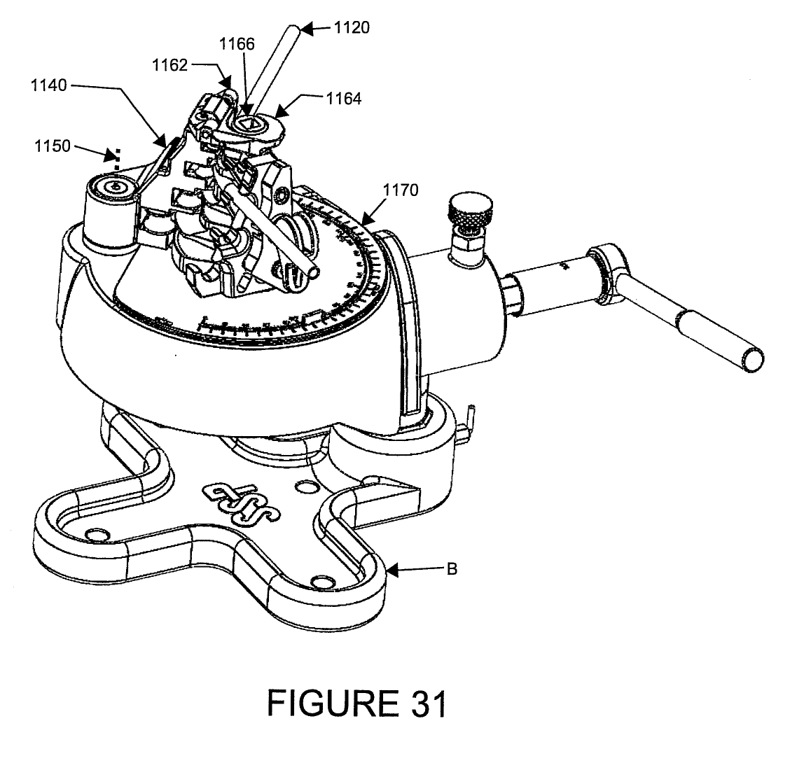

The roll die 1104 has a corresponding set of recesses 1108′, 1110′, 1112′, and 1114′. These recesses 1108′, 1110′, 1112′,1114′ are preferably fixed relative to one another in stacked relation and rotated as a die unit 1104 about an axis such as vertical axis 1150 that is offset and parallel to the vertical axis 1106. The roll die 1104 is rotated away from the bend die in an offset position as illustrated, for example, in FIGS. 28 and 29, while the tube end 1122 is secured by the latch 1130. Once the tube end 1122 is secured to the bend die 1102, the roll die 1104 is rotated about axis 1150 (FIG. 30) toward the bend die to complete a substantial, circumferential capture of the tube 1120 between the bend die and the roll die (FIG. 31). To maintain this circumferential capture of the tube 1120 between the dies 1102, 1104, a second latch such as pivoting latch 1160 is provided on the roll die. The second latch 1160 has a pin 1162 about which the second latch hinges or rotates relative to the remainder of the roll die 1104. Further, the second latch 1160 has a general C-shaped portion 1164 that conforms around an extension or post 1166 at the top of the bend die. Therefore, once the tube end 1122 is secured by the first latch 1130 in a desired mandrel recess of the bend die 1102, the roll die 1104 is rotated about axis 1150 from its position such as shown in FIGS. 28 and 29 toward the bend die (FIG. 30). Once fully rotated into position to complete the circumferential capture of the tube in a desired pair of recesses from the respective bend die 1102 and roll die 1104 (e.g., 1106, 1106′ or 1108, 1108′ or 1110, 1110′ or 1112, 1112′), the second latch 1160 of the roll die is rotated or secured into position about the post 1166 at the top of the bend die (FIG. 31). The top of the post 1166 is configured to receive a driver DR such as a conventional socket wrench head which also serves as a 1:1 drive mechanism as will be described below.

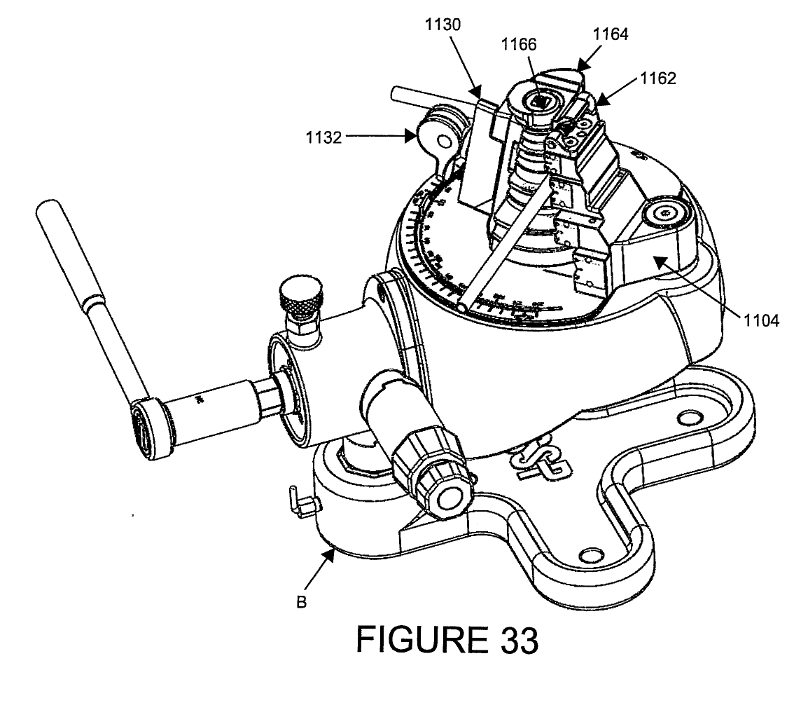

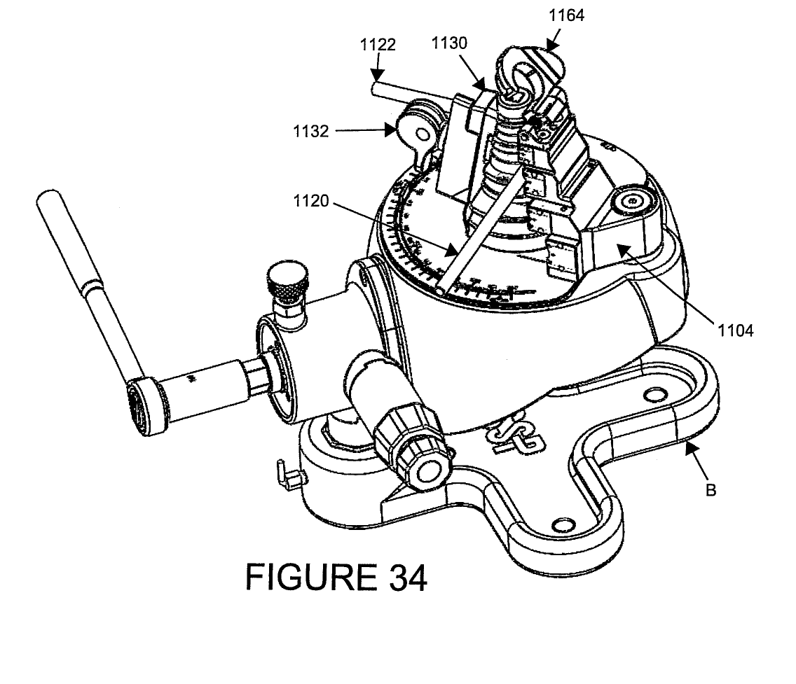

The bend die 1102 is rotationally located relative to the base B at a start position (0 degree position) as shown by gauge 1170 on the base. The driver DR, such as the illustrated socket wrench, is rotated at relative to the base to impart rotational drive motion to the bend die 1102. The bend die 1102 is then advanced or rotated through a desired degree of bending that can be monitored at the gauge 1170. It is contemplated that the driver DR is a ratchet type of drive so that rotation in one direction imparts drive motion to the bend die, while rotation of the driver in the opposite direction may move freely without imparting any drive motion to the bend die. Just as importantly, the ratchet drive mechanism holds the tension or force on the bend die as the ratchet type driver is rotated freely without imparting drive motion to the bend die. Once the desired amount of bending has been imparted to the tube 1120 (i.e., the tube has been bend through a desired angle), the tube latch 1130 is released to free the end 1122 of the tube (FIG. 33). Subsequently, the roll die latch 1160 is then released (FIG. 34) and the roll die rotated about its axis 1150 to allow the tube 1120 to be removed from the tube bender 1100. The position of the bend die 1102 is then released and rotated to its start position relative to the base (0 degrees) and the tube bender 1100 is then ready to receive another tube for bending (FIG. 28).

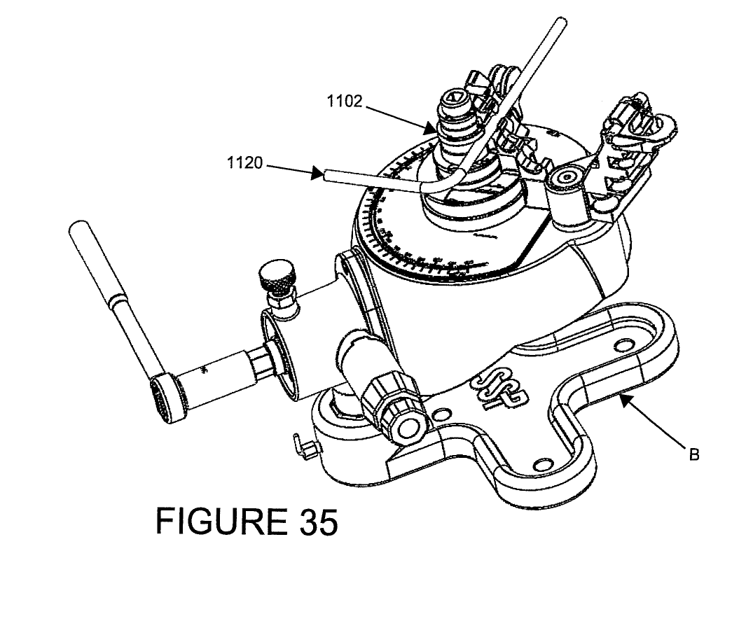

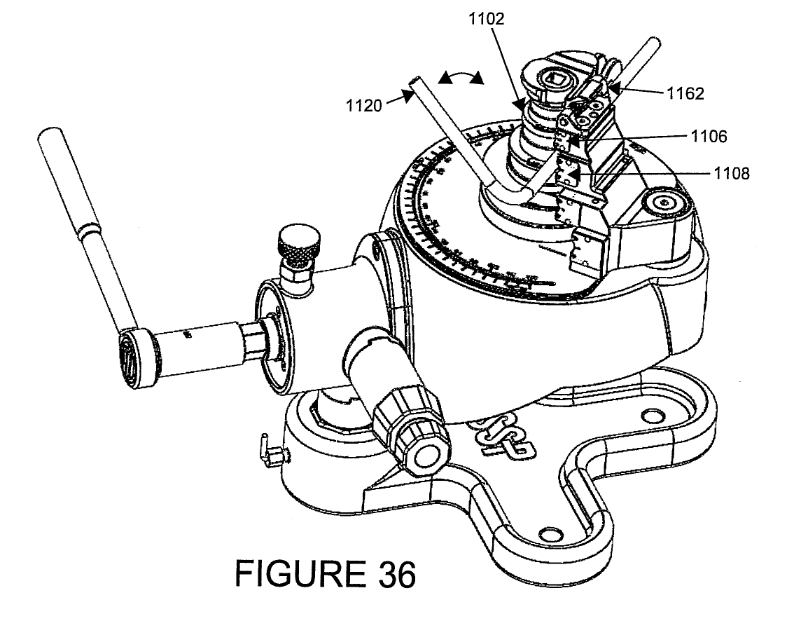

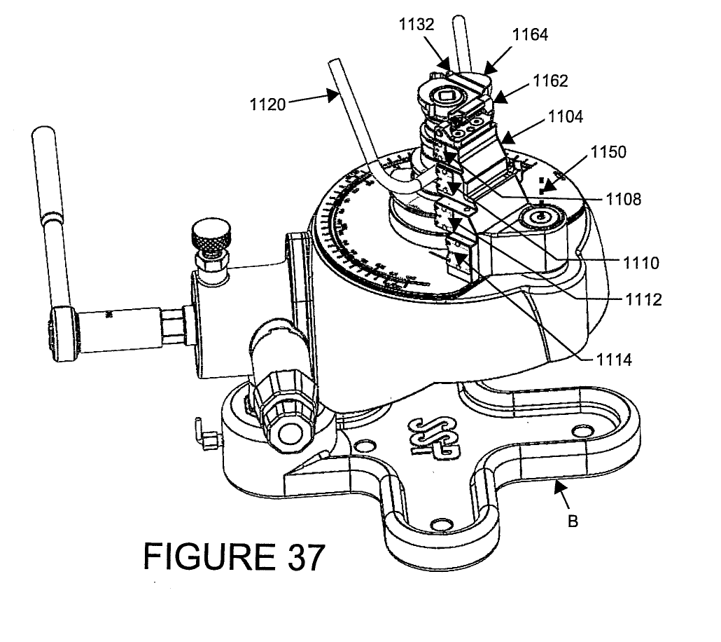

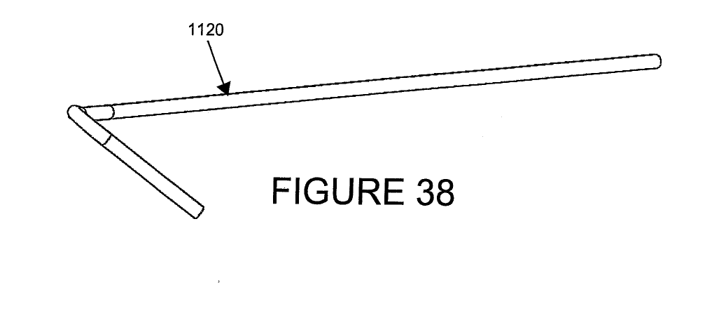

As will be appreciated, one or more bends may be made imparted on a tube 1120. The degree of bending may also be easily measured via the gauge 1170. This allows for precise, repeatable bending of one or more tubes 1120, and it is also contemplated that the tube bender 1100 can be used to form more complex bends in a tube, e.g., multiple bends in a tube, as well as offset bending. More particularly, and as illustrated in FIGS. 35-37, the tube bender 1100 receives a tube 1120 that is pre-bent. The same process for securing the tube 1120 in the tube bender 1100 is followed as described in connection with FIGS. 28-34 above. That is, the tube 1120 is secured between the bend die 1102 and the roll die 1104 at a desired longitudinal position on the tube. Again, the first latch 1130 secures the tube 1120 and a desired longitudinal position in the tube bender 1100 (FIG. 35). Next, the desired offset angle of the tube is verified via an indicator or gauge 1180 provided on the roll die 1104 (FIG. 36). Suitable gradations or angular markings 1180 are provided on the roll die and easily visible to the user to allow the angular position of the prior bend in the tube to be set as desired. That is, the portion of the tube 1102 received in the desired recesses of the bend die and roll die is rotated about its longitudinal axis to orient the second bend to the desired angle. Once the offset angle is verified and set, the first and second latches 1130, 1160 secure the tube 1120 at the desired offset angle and a new bend is imparted to the tube at the desired axial location and at the desired offset angle by operating the driver DR (FIG. 37). The desired degree of this second bend in the tube is monitored via gauge 1170. In the same manner as described above, once the second or subsequent bend is complete, the tube 1120 is released from the tube bender 1100. By opening the latches 1130, 1160, and rotating the roll die 1104 away from the bend die 1102, the tube is removed from the tube bender—complete with the desired offset bend (FIG. 38).

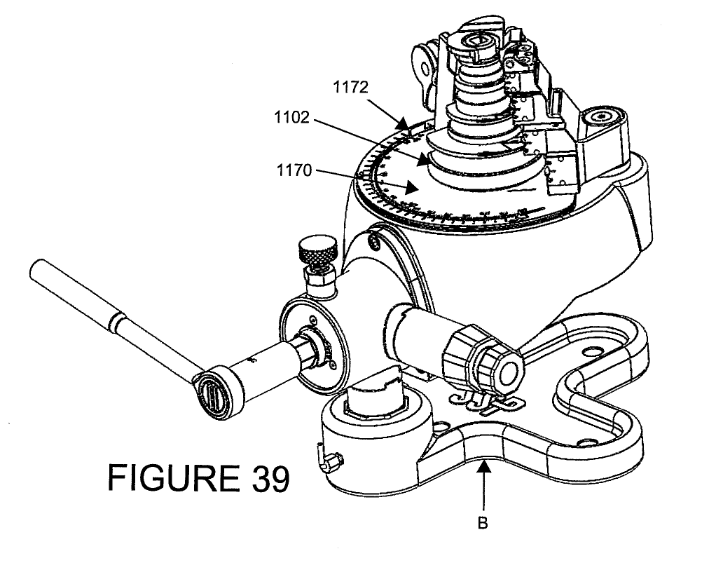

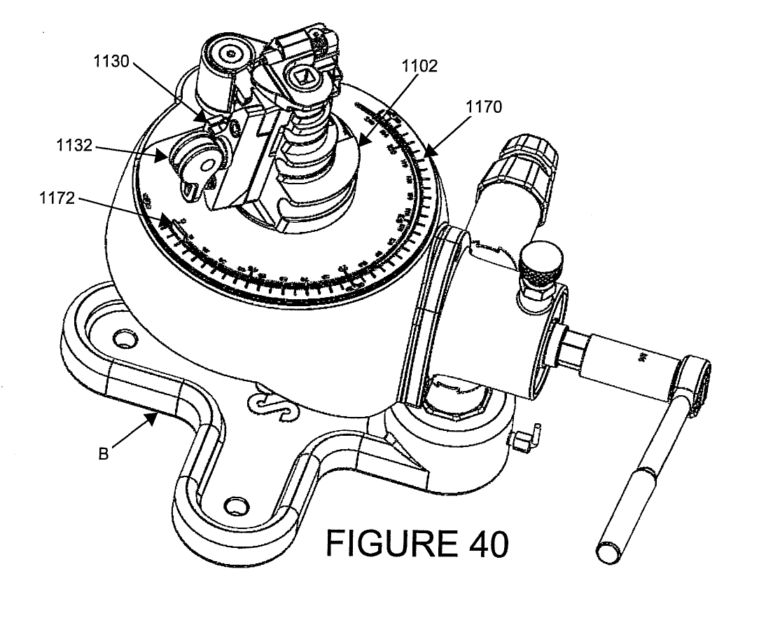

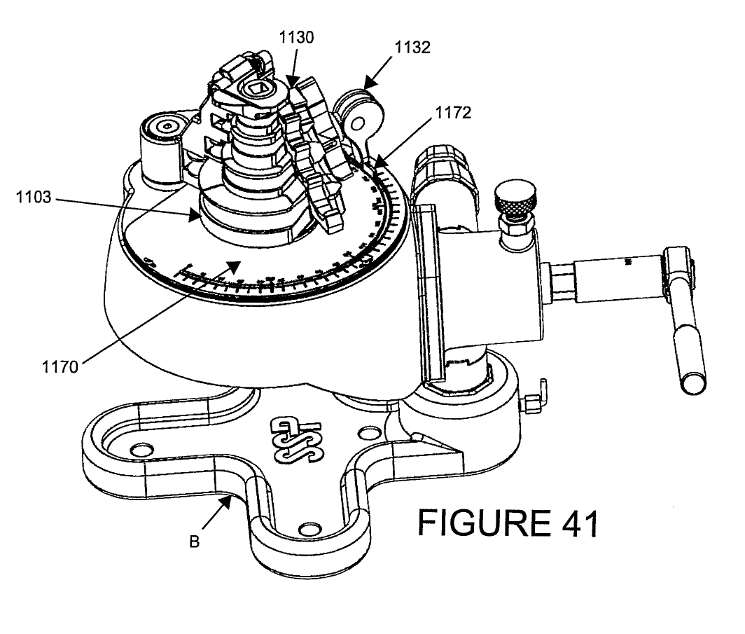

The gauge 1170 on the base B is more particularly illustrated FIGS. 39-41. The ratchet drive mechanism assures that once the desired amount of bend is imparted to the tube, the tension remains on the tube 1120 until further bending is imparted thereto, or the tube is removed from the bender 1100. A high degree of accuracy in the degree of bend is also achievable with an indicator or needle 1172 that rotates with the bend die. The indicator will show the extent of the bend and will hold the measurement value so that the bending process can be accurately repeated on additional tubes.

As will be appreciated, the subject, tube bender 1100 is provided with a base mounting system for optimal versatility and pending applications. The tube bender can be mounted in a variety of orientations and angles to accommodate almost any type of bend. The bender uses standard profile dies and rollers to bend tubing at a precise and measured angle with little flattening or distortion. The tube bender also has the capability to provide angle indicators for rotating the tube to make bends in different planes. After placing a tube in the proper sized die, the user can utilize the quick release tube clamp or latch to hold the tube in place. The user positions the roller die and the roller die self-locks in place. For small gauge tubing bends, a standard ⅜ inch drive ratchet can be inserted directly into the drive on the top of the central bend die for 1:1 bending. The angled degree indicator will move with the bend die and hold the last measurement for accurate repetition of multiple bends. If the tube is a heavier wall construction that requires more force, the horizontal ¾″ hex-drive can be used with a socket, wrench, or similar tool where the operator will gain a 5:1 gear ratio for easier bending. There is a built-in anti-spring back ratchet lock to prevent the tube from losing tension when advancing through a heavy bend. This ratchet lock can be quickly engaged or disengaged without tools depending on the user's preference.

A gear drive provides ratchet action to minimize user effort in bending heavy wall tubing. Common size tubing is addressed in a single station, and no change parts or additional procedures are required to accommodate different sized tubes. The system is capable of bends in excess of 180°, and facilitates complex shapes with accurate bends in multiple planes. The single stack design of the bend die allows for bending multiple size tubing without any change over or additional components. The base is designed to allow the entire tube bender to change orientation, including vertical mounting for complex bends. The tube bender advantageously provides industry standard bend radii for each tube size. A sliding band indicator for making successive bends or providing a pre-calculated target to compensate for spring back is also provided. Likewise, angle indicators for off-plane bends are incorporated into the system. The accurate, integrated gauge indicates the bend angle during the bend process.

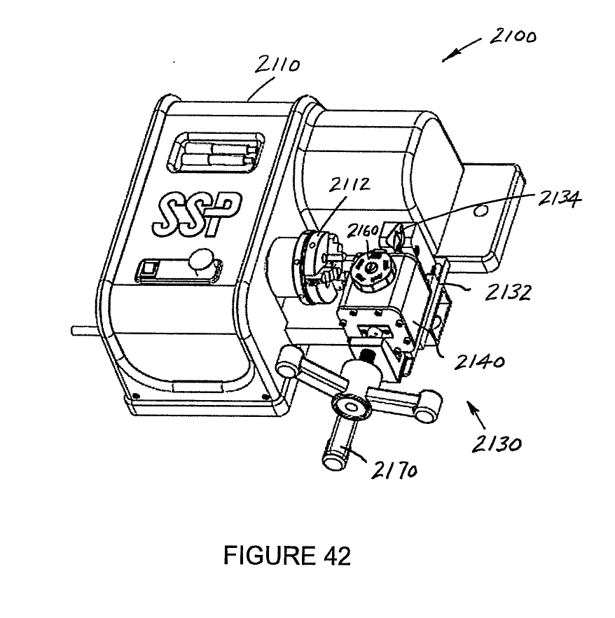

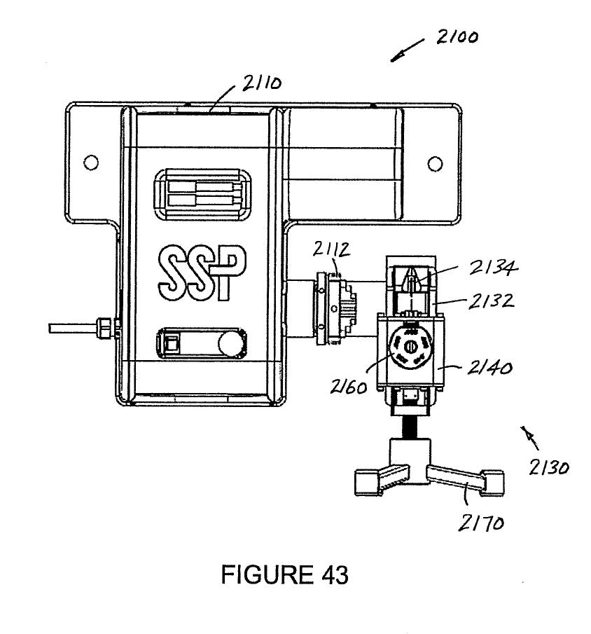

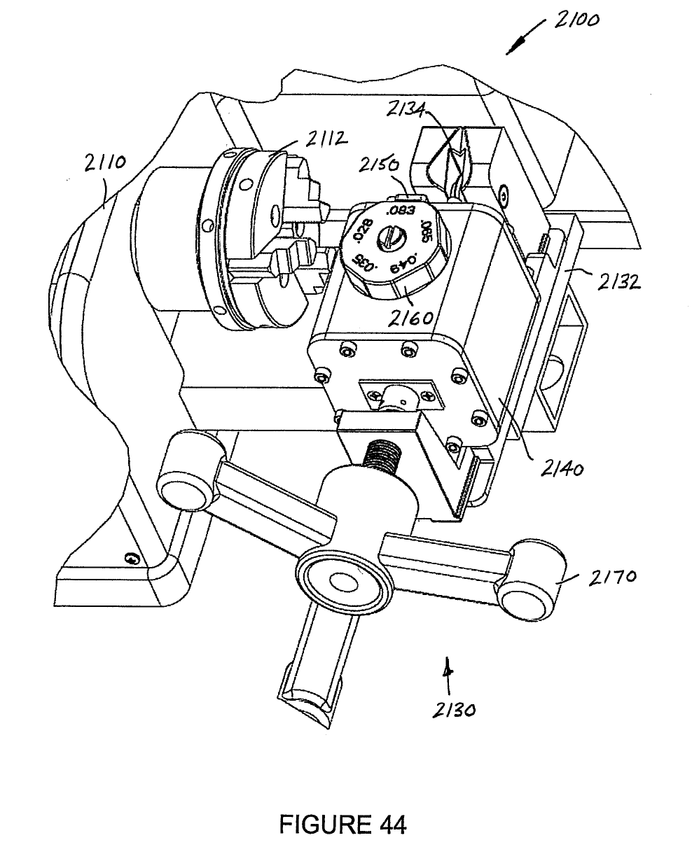

Turning to FIGS. 42-45, there is shown the tube cutter 2100 that has a housing 2110 that may be selectively secured to a bench top, or work surface. The housing encloses a drive motor (not shown) that rotatably drives a clamping assembly, such as a three jaw chuck 2112, that receives an associated tube 2120 therein. The tube 2120 is loaded into the housing 2110 on one side, for example through an opening (not shown) on the left side of the housing of FIG. 43. The opening is aligned with the chuck 2112 so that a leading and of the elongated tube is inserted into the opening and through a central portion of the clamping assembly/chuck 2112. Once the chuck 2112 is tightened on an outer perimeter of the tube 2120 at a desired axial location, the rotational movement imparted by the motor will rotate the tube at a desired speed.

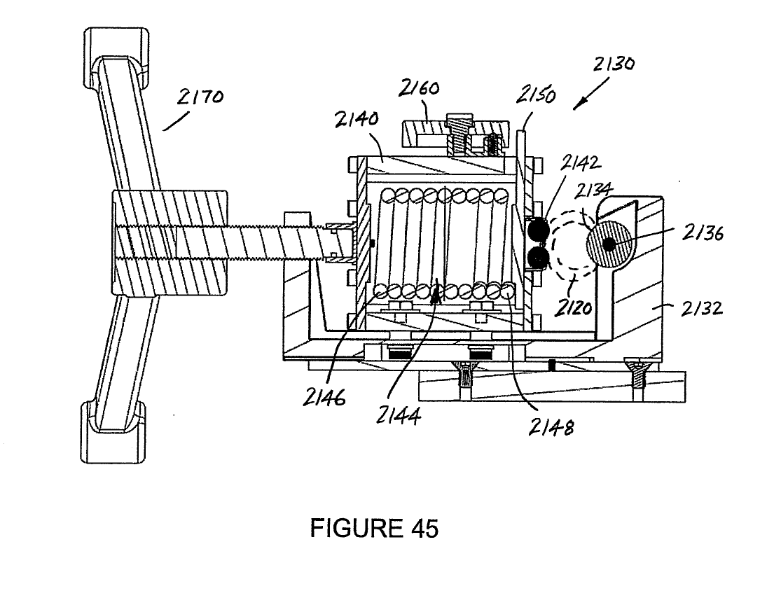

A cutting assembly 2130 is adapted to receive the tube 2120 therein (FIG. 45). The cutting assembly 2130 may be an integral part of the housing 2110, or may be movable relative thereto (compare FIG. 43 and FIGS. 46-47). The cutting assembly 2130 includes a support 2132 (FIG. 45) to which is rotatably mounted a cutter wheel 2134 that rotates about axis 2136. A block 2140 is slidably mounted on the support 2132. Rotatable bearings 2142 are provided on the block and adapted to engage the perimeter surface of the tube 2120, preferably at a location diametrically opposite that of the cutting wheel 2134. A biasing member such as coil spring 2144 is provided in the block 2140. The biasing spring 2144 has one end 2146 that abuts against an inner wall of the block while the other end 2148 abuts against a wall thickness gauge 2150. In addition, rotatably received on the block 2140 is a wall thickness dial or adjustment member 2160.

A hand wheel 2170 is threadably engaged with the support 2132. Once the user selects the wall thickness corresponding to the size of tube being cut on the wall thickness dial 2160, the hand wheel is tightened until the wall thickness gauge 2150 abuts against the wall thickness dial 2160. It will be appreciated wall thickness dial has a variable perimeter or circumferential dimension. The biasing spring exerts a constant force on the tube 2120 through the gauge 2150 that in turn abuts against bearings 2142. As the cutter wheel advances through the sidewall of the rotating tube, the gauge 2150 advances toward the adjustment member 2160 and bottoms out when the tube is completely cut. Preferably, the motor rotates the chuck 2112 and tube 2120 at a desired, constant rate. The rotational speed of the cutting head is optimized for cutter wear, cutting speed, and safety.

With the tube cut at the desired location, the power driven chuck 2112 can also be used in the deburring process. A conventional handheld, deburring tool (not shown) has a first surface portion that engages the outer diameter of the cut tube end, and a second surface portion that engages the inner diameter of the cut tube end. Manually holding the deburring tool while the tube end rotates via the motive power supplied to the chuck easily deburrs the cut tube end.

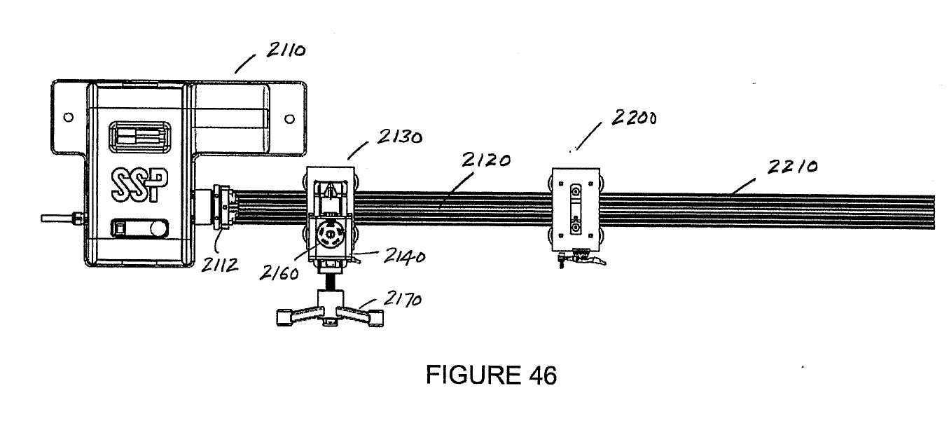

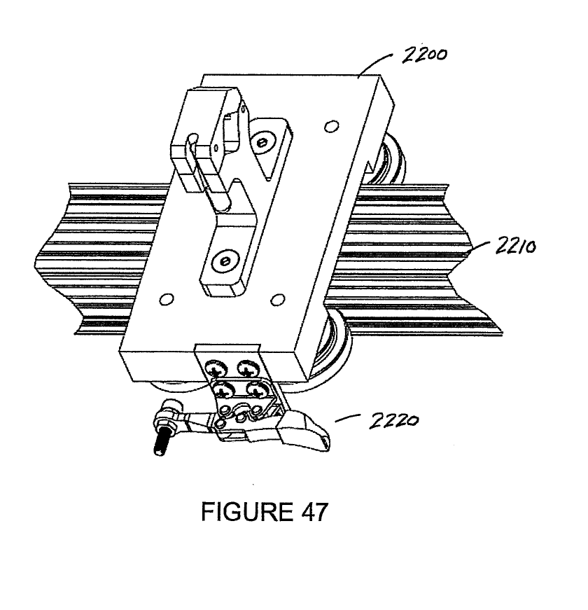

When a substantial length of tubing is inserted into the tube cutter, an auxiliary support 2200 may be provided at a spaced location from the housing 2110 and/or from the cutting assembly 2130. Specifically, and as best illustrated in FIGS. 46-47, the cutting assembly 2130 and the auxiliary support 2200 may be mounted on rail 2210. A quick release clamp 2220 is provided on each of the cutting assembly 2130 and the auxiliary support 2200. The quick release clamp 2220 allows for a quick clamp/unclamp of the component relative to the rail 2210 so that either the cutting assembly, or the auxiliary support can be longitudinally moved/reposition along the rail.

The above-described tube cutter 2100 is a stand-alone unit that may be powered by standard 120V electrical outlet. Using a three jaw chuck, the tube received in the cutter is positioned to be cut at a desired length. Next, the user selects the wall thickness corresponding to the size of tube being by properly positioning the wall thickness dial. A hand wheel is then tightened until the wall thickness gauge bottoms out on the wall thickness dial, and then power is turned on. As the tube rotates, the cutter wheel is automatically advanced with the proper force until the tube is completely cut. The user then turns off the power and removes the tube from the tube cutter. Removing burrs on the inner diameter of the cut tube and creating an edge break on the outer diameter thereof can be easily accomplished by using a reamer manually held against the newly cut tube end, and rotating the tube in the cutting station or by hand.

Multiple rows of bearings, e.g. triple rows of bearings, increase cutter efficiency and reduce marring and collapse of the tube. Burrs on the inner diameter of the cut tube are minimized, and likewise no burrs are present on the outer diameter. The cutter wheel is continuously advanced which reduces cutting time and lengthens the useful life of the cutter wheel, although if replacement is required, standard size cutting wheels are widely available and easily changed. The cutting wheel also self-centers on tubes of different diameters. The auto feed cutter. Minimizes chamfering of the cut end of the tube, and instead results in controlled, squared cuts. No tool changeover is required for switching tube diameters or wall thicknesses. The subject tube cutter facilitates quick, accurate markings of bend references. For elongated tubes, and an auxiliary outboard support is provided. The rotation or rpm of the cutting head is optimized for cutter wear, cutting speed, and safety. By using the power spindle, the user can easily deburr the inner diameter and outer diameter of the recently cut tube end; alternatively, a vacuum/blower can also be used for clearing chips from the deburring process. Tube crush is virtually eliminated, even in thin walled tubing. The self-aligning and self-advancing arrangement provides for a high consistency and accuracy in every cut independent of operator technique. The subject tube cutter is capable of accepting tube lengths from 2½ inches in length, up to the industry-standard 20 foot lengths, and the auxiliary support can be used with the longer tube lengths. The system can be used on tubing up to ½ inch fractional, 12 mm metric, of different wall thicknesses. The tube cutter is easy to use, ready to use only minutes of installation, and an optional measurement rail add-on allows a movable cutting head to precisely measure cut links without needing any extra tools or require any time-consuming steps to pre-measure and mark by hand.

This written description uses examples to describe the disclosure, including the best mode, and also to enable any person skilled in the art to make and use the disclosure. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

1. A cartridge comprising:
a body having first and second spaced walls that form an internal cavity dimensioned to receive an associated nut therein and hold the associated nut from rotation relative to the body;
an advancement surface on the body configured for engagement to move the body;
at least one retention finger for holding the associated nut within the internal cavity of the body; and
and a keying feature on the body adapted for engagement by an associated locking mechanism that determines whether the associated nut is separated from the body.

2. The cartridge of claim 1 wherein the at least one retention finger further comprises a deflectable holding member that extends into engagement with the associated nut and deforms in response to a predetermined force to allow the associated nut to be removed from the body.

3. The cartridge of claim 1 wherein the at least one retention finger includes at least one frangible finger that separates from the body in response to a predetermined force to allow the associated nut to be removed from the body.

4. The cartridge of claim 1 wherein the body is formed from plastic and is joined to at least one contiguous like body.

5. The cartridge of claim 4 wherein the contiguous bodies are joined by frangible connections.

6. A cartridge feed system for a tube fitting assembly that includes first and second annular ferrules received on a tube and swaged in place between a nut and body, the feed system including:
a mechanism loading station dimensioned to receive the cartridge of claim 1.

7. The cartridge feed system of claim 6 wherein the cartridge includes a nut having first and second ferrules received in the nut, and an advancing mechanism that engages the advancing surface on the cartridge to advance the cartridge to a loading station.

8. The cartridge feed system of claim 6 further comprising a locking mechanism that engages the keying feature on the body, and if the locking mechanism engages the body, a plunger is freed for advancement to move toward the cartridge and breaks the cartridge from a contiguous cartridge.

9. The cartridge feed system of claim 6 further comprising a movable plug mounted for advancement into one end of the nut and first and second ferrules for holding the nut and ferrules in aligned position as the advancing mechanism separates the cartridge from the contiguous cartridge.

10. The cartridge feed system of claim 9 wherein the plug moves with the advancing mechanism during the separation of the cartridge from the contiguous cartridge.

11. The cartridge feed system of claim 6 further comprising an opening dimensioned to receive one end of a tube therein for axial advancement relative to the nut and ferrules after the nut and ferrules have been removed from the cartridge.

12. The cartridge feed system of claim 6 further comprising a plug housing that receives the plug as the tube is axially inserted into the nut and ferrules.

13. The cartridge feed system of claim 6 wherein the plug moves away from the tube end with the nut and ferrules received thereon.

14. The cartridge feed system of claim 6 wherein the contiguous, next cartridge is advanced into the loading position, and any additional joined cartridges are advanced seriatim toward the loading position.

15. The cartridge feed system of claim 6 further comprising a pre-swaging device that includes a generally U-shaped die barrel configured to receive the nut and first and second ferrules therein, and a force applying mechanism that pre-swages the ferrules on the tube.

16. The cartridge feed system of claim 6 wherein the loading station is dimensioned to receive a nut having first and second ferrules received in the nut; and further comprising an advancing mechanism that advances the nut with ferrules into the loading station.

17. The feed system of claim 16 wherein the advancing mechanism separates a cartridge containing a nut with the first and second ferrules received therein from like cartridges that each includes a nut containing first and second ferrules therein.

18. The feed system claim 16 wherein the advancing mechanism includes a movable plug having a first end dimensioned for receipt inside the first and second ferrules, where the movable plug is actuated into central openings in the first and second ferrules.

19. A tube bender comprising:
a mandrel including at least one recess dimensioned to receive an associated tube;
a base operatively secured to the mandrel, the base configured to alternatively allow the mandrel to be mounted in one of different first and second positions relative to the base.

20. The tube bender of claim 19 wherein the base includes a plate mounted to an associated work surface.

21. The tuber bender of claim 19 further comprising a first slot dimensioned to receive the base in the first position, and a second slot substantially perpendicular to the first slot dimensioned to receive the base in the second position.
